(19) United States
(12) Patent Application Publication
(10) Pub. No.: US 2026/0032284 A1
(43) Pub. Date: Jan. 29, 2026

(54) POINT CLOUD DECODING DEVICE, POINT CLOUD DECODING METHOD, AND PROGRAM

(71) Applicant: KDDI CORPORATION, Tokyo (JP)

(72) Inventors: Kyohei UNNO, Fujimino-shi (JP); Satoshi KOMORITA, Fujimino-shi (JP); Kei KAWAMURA, Fujimino-shi (JP)

(73) Assignee: KDDI CORPORATION, Tokyo (JP)

(21) Appl. No.: 19/348,979

(22) Filed: Oct. 3, 2025

Related U.S. Application Data
(63) Continuation of application No. PCT/JP2024/008380, filed on Mar. 5, 2024.

(30) Foreign Application Priority Data
Apr. 14, 2023 (JP) 2023-066594

(51) Int. Cl. H04N 19/597; H04N 19/136; H04N 19/174; H04N 19/70; H04N 19/96

(52) U.S. Cl. CPC H04N 19/597; H04N 19/136; H04N 19/174; H04N 19/70; H04N 19/96

(57) ABSTRACT

A point cloud decoding device 200 according to the present invention includes a circuit, wherein the circuit decodes vertex information of Trisoup, the vertex information includes at least one of a presence or absence of a vertex for each unique segment or a vertex position for each unique segment, the presence or absence of the vertex and the position of the vertex are each decoded using a plurality of contexts, and the contexts are prepared in a minimum necessary number based on values takeable by the context, and initialized before the decoding processing.

### CROSS-REFERENCE TO RELATED APPLICATIONS

The present application is a continuation of PCT Application No. PCT/JP2024/008380, filed on Mar. 5, 2024, which claims the benefit of Japanese patent application No. 2023-066594 filed on Apr. 14, 2023; the entire contents of each application being incorporated herein by reference in its entirety.

### TECHNICAL FIELD

The present invention relates to a point cloud decoding device, a point cloud decoding method, and a program.

### BACKGROUND ART

Reference 1 (“G-PCC Future Enhancement, ISO/IEC JTC1/SC29/WG11 N19328”) discloses an encoding technology for geometry information, which is called Trisoup.

### SUMMARY OF THE INVENTION

However, the method of Reference 1 has a problem that Trisoup can be executed only for a fixed node size for each slice.

Therefore, the present invention has been made in view of the above-described problem, and an object of the present invention is to provide a point cloud decoding device, a point cloud decoding method, and a program, which enable improvement in encoding efficiency by generating a predicted value of a vertex position at a small node size based on a vertex position decoded at a large node size and encoding/decoding a difference from the vertex position at the small node size in Trisoup for a plurality of node sizes.

A first feature of the present invention is a point cloud decoding device including an approximate-surface synthesizing unit configured to decode vertex information of Trisoup at each node size in descending order of a node size, in which the vertex information includes at least one of the presence or absence of a vertex for each unique segment or a vertex position for each unique segment, and in a case where a decoded node size larger than a target node size is present, the approximate-surface synthesizing unit generates a predicted value of the vertex information at the target node size based on the vertex information at the decoded node size, and decodes the vertex information at the target node size by using the predicted value.

A second feature of the present invention is a point cloud decoding device including an approximate-surface synthesizing unit configured to decode vertex information of Trisoup, in which the vertex information includes at least one of the presence or absence of a vertex for each unique segment or a vertex position for each unique segment, the presence or absence of the vertex and the position of the vertex are each decoded using a plurality of contexts, and the contexts are prepared in a minimum necessary number based on values takeable by the context, and initialized before the decoding processing.

A third feature of the present invention is a point cloud decoding method including a step of decoding vertex information of Trisoup at each node size in descending order of a node size, in which the vertex information includes at least one of the presence or absence of a vertex for each unique segment or a vertex position for each unique segment, and in the step, in a case where a decoded node size larger than a target node size is present, a predicted value of the vertex information at the target node size is generated based on the vertex information at the decoded node size, and the vertex information at the target node size is decoded by using the predicted value.

A fourth feature of the present invention is a program for causing a computer to function as a point cloud decoding device, in which the point cloud decoding device includes an approximate-surface synthesizing unit configured to decode vertex information of Trisoup at each node size in descending order of a node size, the vertex information includes at least one of the presence or absence of a vertex for each unique segment or a vertex position for each unique segment, and in a case where a decoded node size larger than a target node size is present, the approximate-surface synthesizing unit generates a predicted value of the vertex information at the target node size based on the vertex information at the decoded node size, and decodes the vertex information at the target node size by using the predicted value.

According to the present invention, it is possible to provide a point cloud decoding device, a point cloud decoding method, and a program, which enable improvement in encoding efficiency by generating a predicted value of a vertex position at a small node size based on a vertex position decoded at a large node size and encoding/decoding a difference from the vertex position at the small node size in Trisoup for a plurality of node sizes.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram illustrating an example of a configuration of encoded data (bit stream) received by a geometry information decoding unit 2010 of the point cloud decoding device 200 according to an embodiment.

FIG. 4 is a diagram illustrating an example of a syntax configuration of a geometry parameter set (GPS) 2011.

FIG. 5 is a diagram illustrating an example of a syntax configuration of a geometry slice header (GSH) 2012.

FIG. 6 is a flowchart illustrating an example of processing in a tree synthesizing unit 2020 of the point cloud decoding device 200 according to an embodiment.

FIG. 7 is a flowchart illustrating an example of processing in an approximate-surface synthesizing unit 2030 of the point cloud decoding device 200 according to an embodiment.

FIG. 8 is a flowchart illustrating an example of processing of step S703 illustrated in FIG. 7.

FIG. 9 is a flowchart illustrating an example of processing of step S704 illustrated in FIG. 7.

FIG. 10 is a flowchart illustrating a specific example of a method of generating mask information.

FIG. 11 is a diagram illustrating an example of generation of a segment and a mask value.

FIG. 12 is a flowchart illustrating an example of processing of step S705 illustrated in FIG. 7.

FIG. 13 is a flowchart illustrating an example of processing of step S706 illustrated in FIG. 7.

FIG. 14 is a flowchart illustrating an example of processing of step S708 illustrated in FIG. 7.

FIG. 15A is a diagram for describing an example of processing of step S1302 in FIG. 13.

FIG. 15B is a diagram for describing an example of the processing of step S1302 in FIG. 13.

FIG. 16A is a diagram for describing an example of processing of step S705 in FIG. 7.

FIG. 16B is a diagram for describing an example of processing of step S706 in FIG. 7.

FIG. 16C is a diagram for describing an example of processing of step S708 in FIG. 7.

FIG. 17 is a diagram for describing an example of processing in the approximate-surface synthesizing unit 2030 of the point cloud decoding device 200 according to an embodiment.

FIG. 18A is a diagram for describing an example of a context setting method in the point cloud decoding device 200 according to an embodiment.

FIG. 18B is a diagram for describing an example of the context setting method in the point cloud decoding device 200 according to an embodiment.

FIG. 19A is a diagram for describing an example of the context setting method in the point cloud decoding device 200 according to an embodiment.

FIG. 19B is a diagram for describing an example of the context setting method in the point cloud decoding device 200 according to an embodiment.

FIG. 19C is a diagram for describing an example of the context setting method in the point cloud decoding device 200 according to an embodiment.

FIG. 20 is a diagram for describing an example of the context setting method in the point cloud decoding device 200 according to an embodiment.

FIG. 21 is a diagram for describing an example of the context setting method in the point cloud decoding device 200 according to an embodiment.

FIG. 22 is a diagram for describing an example of the context setting method in the point cloud decoding device 200 according to an embodiment.

FIG. 23 is a flowchart illustrating an example of processing of decoding the presence or absence of a vertex and a vertex position based on information regarding an “interpolated vertex” by the approximate-surface synthesizing unit 2030 of the point cloud decoding device 200 according to an embodiment.

FIG. 24 is a flowchart illustrating an example of the processing of decoding the presence or absence of the vertex and the vertex position based on the information regarding the “interpolated vertex” by the approximate-surface synthesizing unit 2030 of the point cloud decoding device 200 according to an embodiment.

FIG. 25 is a flowchart illustrating an example of the processing of decoding the presence or absence of the vertex and the vertex position based on the information regarding the “interpolated vertex” by the approximate-surface synthesizing unit 2030 of the point cloud decoding device 200 according to an embodiment.

FIG. 26 is a diagram illustrating an example of functional blocks of a point cloud encoding device 100 according to the present embodiment.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

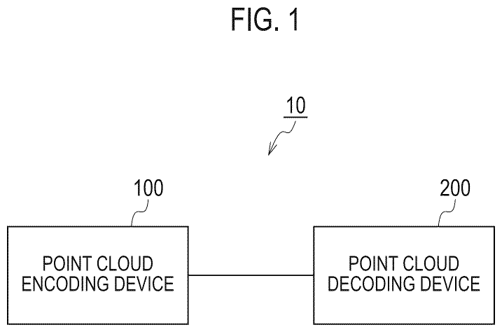

Hereinafter, a point cloud processing system 10 according to a first embodiment of the present invention will be described with reference to FIGS. 1 to 26. FIG. 1 is a diagram illustrating the point cloud processing system 10 according to an embodiment of the present embodiment.

As illustrated in FIG. 1, the point cloud processing system 10 includes a point cloud encoding device 100 and a point cloud decoding device 200.

The point cloud encoding device 100 is configured to generate encoded data (bit stream) by encoding an input point cloud signal. The point cloud decoding device 200 is configured to generate an output point cloud signal by decoding the bit stream.

Note that the input point cloud signal and the output point cloud signal include position information and attribute information of each point in a point cloud. The attribute information is, for example, color information or a reflection ratio of each point.

Here, such a bit stream may be transmitted from the point cloud encoding device 100 to the point cloud decoding device 200 through a transmission path. Furthermore, the bit stream may be stored in a storage medium, and then provided from the point cloud encoding device 100 to the point cloud decoding device 200.

### (Point Cloud Decoding Device 200)

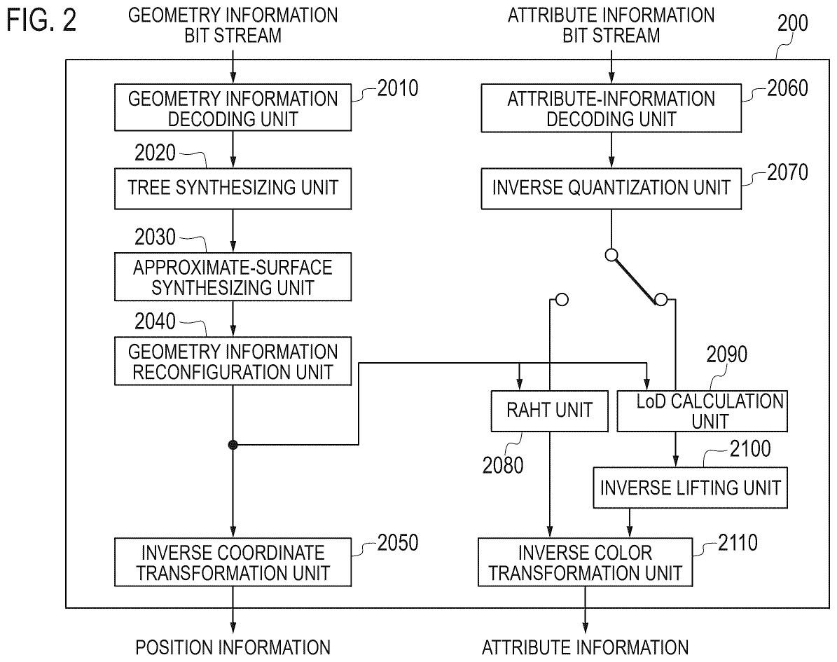

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes a geometry information decoding unit 2010, a tree synthesizing unit 2020, an approximate-surface synthesizing unit 2030, a geometry information reconfiguration unit 2040, an inverse coordinate transformation unit 2050, an attribute-information decoding unit 2060, an inverse quantization unit 2070, a region adaptive hierarchical transform (RAHT) unit 2080, a level-of-detail (LoD) calculation unit 2090, an inverse lifting unit 2100, and an inverse color transformation unit 2110.

The geometry information decoding unit 2010 is configured to use, as input, a bit stream about geometry information (geometry information bit stream) among bit streams output from the point cloud encoding device 100, and to decode syntax.

Decoding processing is, for example, context-adaptive binary arithmetic decoding processing. Here, for example, the syntax includes control data (flags and parameters) for controlling the decoding processing of the position information.

The tree synthesizing unit 2020 is configured to use, as input, the control data, which has been decoded by the geometry information decoding unit 2010, and an occupancy code indicating on which node in a tree described later a point cloud is present, and to generate tree information indicating in which region in a decoding target space points are present.

Note that the tree synthesizing unit 2020 may be configured to perform decoding processing of an occupancy code.

The present process can generate the tree information by recursively repeating processing of partitioning the decoding target space into cuboids, determining whether or not a point is present in each cuboid by referring to the occupancy code, dividing the cuboid in which the point is present into a plurality of cuboids, and referencing the occupancy code.

Here, inter prediction may be used in decoding the occupancy code.

In the present embodiment, it is possible to use a method called “octree” in which octree division is recursively carried out with the above-described cuboids always as cubes, and a method called “QtBt” in which quadtree division and binary tree division are carried out in addition to octree division. Whether or not “QtBt” is to be used is transmitted as the control data from the point cloud encoding device 100 side.

In the present embodiment, a method of decoding the geometry information by performing division by “octree” until the cube has a size of 1×1×1 is particularly referred to as “octree only”.

Also in a case where “QtBt” is used in combination with “octree”, a method of decoding the geometry information by performing division with only “octree” and “QtBt” until the cuboid has a size of 1×1×1, as described above, may also be referred to as “octree only”.

Alternatively, the tree synthesizing unit 2020 is configured to, when the control data designates use of predictive geometry coding, decode the coordinates of each point based on an arbitrary tree configuration determined by the point cloud encoding device 100.

The approximate-surface synthesizing unit 2030 is configured to generate approximate-surface information using the tree information generated by the tree synthesizing unit 2020, and decode a point cloud based on this approximate-surface information.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

More specifically, the approximate-surface synthesizing unit 2030 can generate the approximate-surface information and decode the point cloud by, for example, a method called “Trisoup”. A specific “Trisoup” processing example will be described later. In addition, when decoding a sparse point cloud acquired by Lidar or the like, the present processing can be omitted.

The geometry information reconfiguration unit 2040 is configured to reconfigure the geometry information (position information on the coordinate system assumed by the decoding processing) of each point of decoding target point cloud data based on the tree information generated by the tree synthesizing unit 2020 and the approximate-surface information generated by the approximate-surface synthesizing unit 2030.

The inverse coordinate transformation unit 2050 is configured to use, as input, the geometry information reconfigured by the geometry information reconfiguration unit 2040, to transform the coordinate system assumed by the decoding processing into a coordinate system of the output point cloud signal, and to output the position information.

The attribute-information decoding unit 2060 is configured to use, as input, a bit stream (attribute-information bit stream) about the attribute information among the bit streams output from the point cloud encoding device 100, and to decode syntax.

The decoding processing is, for example, context-adaptive binary arithmetic decoding processing. Here, for example, the syntax includes control data (flags and parameters) for controlling the decoding processing of the attribute information.

Furthermore, the attribute-information decoding unit 2060 is configured to decode quantized residual information from the decoded syntax.

The inverse quantization unit 2070 is configured to perform an inverse quantization process based on the quantized residual information decoded by the attribute-information decoding unit 2060 and quantization parameters that are one of items of the control data decoded by the attribute-information decoding unit 2060, and to generate inverse-quantized residual information.

The inverse-quantized residual information is output to one of the RAHT unit 2080 and the LoD calculation unit 2090 according to a feature of the decoding target point cloud. To which one of the RAHT unit 2080 and the LoD calculation unit 2090 the inverse-quantized residual information is output is designated by the control data decoded by the attribute-information decoding unit 2060.

The RAHT unit 2080 is configured to use, as input, the inverse-quantized residual information generated by the inverse quantization unit 2070, and the geometry information generated by the geometry information reconfiguration unit 2040, and to decode the attribute information of each point by using a type of Haar transformation (that is inverse Haar transformation in the decoding processing) called Region Adaptive Hierarchical Transform (RAHT). As specific processes of the RAHT, for example, the method described in Reference 1 can be used.

The LoD calculation unit 2090 is configured to use, as input, the geometry information generated by the geometry information reconfiguration unit 2040, and to generate a Level of Detail (LoD).

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Reference 1 described above may be used.

The inverse lifting unit 2100 is configured to decode the attribute information of each point based on a hierarchical structure defined by the LoD using the LoD generated by the LoD calculation unit 2090 and the inverse-quantized residual information generated by the inverse quantization unit 2070. As specific processes of inverse lifting, for example, the method described in Reference 1 described above can be used.

The inverse color transformation unit 2110 is configured to, when the attribute information of the decoding target is the color information, and color transformation has been carried out on the point cloud encoding device 100 side, perform an inverse color transformation process on the attribute information output from the RAHT unit 2080 or the inverse lifting unit 2100. Whether or not to perform the inverse color transformation process is determined according to the control data decoded by the attribute-information decoding unit 2060.

The point cloud decoding device 200 is configured to decode and output the attribute information of each point in the point cloud by the above processes.

### (Geometry Information Decoding Unit 2010)

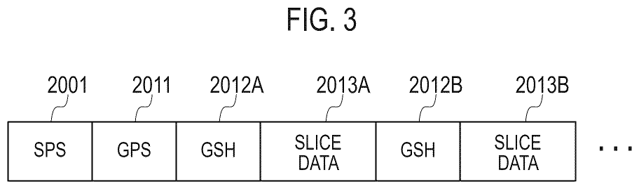

The control data decoded by the geometry information decoding unit 2010 will be described below with reference to FIGS. 3 to 5.

FIG. 3 illustrates an example of a configuration of encoded data (bit stream) received by the geometry information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for identifying the individual GPSs 2011 in a case where there are the plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, a description will be given using the term “slice”, but the slice may be read as a data unit. A specific example thereof will be described later. The GSH 2012A/2012B includes at least GPS id information for designating the GPS 2011 associated with each of the GSH 2012A/2012B.

Third, the bit stream may include slice data 2013A/2013B in addition to the GSH 2012A/2012B. The slice data 2013A/2013B includes data obtained by encoding the geometry information. An example of the slice data 2013A/2013B includes the occupancy code to be described later.

As described above, the bit stream is configured such that each slice data 2013A/2013B is associated with the GSH 2012A/2012B and the GPS 2011 one by one.

As described above, since which GPS 2011 is referred to in the GSH 2012A/2012B is designated by the GPS id information, the GPS 2011 common to a plurality of items of slice data 2013A/2013B can be used.

In other words, the GPS 2011 does not necessarily need to be transmitted for each slice. For example, the bit stream may be configured such that the GPS 2011 is not encoded immediately before the GSH 2012B and the slice data 2013B as in FIG. 3.

Note that the configuration in FIG. 3 is merely an example. As long as each slice data 2013A/2013B is configured to be associated with the GSH 2012A/2012B and the GPS 2011, an element other than those described above may be added as a constituent element of the bit stream.

For example, as illustrated in FIG. 3, the bit stream may include a sequence parameter set (SPS) 2001. Similarly, the bit stream may have a configuration different from that in FIG. 3 at the time of transmission. Furthermore, the bit stream may be synthesized with a bit stream decoded by the attribute-information decoding unit 2060 described later and transmitted as a single bit stream.

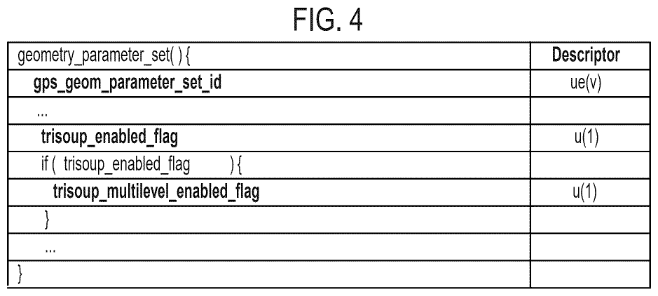

FIG. 4 illustrates an example of a syntax configuration of the GPS 2011.

Note that syntax names described below are merely examples. The syntax names may vary as long as the functions of the syntaxes described below are similar.

The GPS 2011 may include GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (trisoup_enabled_flag) that controls whether or not to use Trisoup in the approximate-surface synthesizing unit 2030.

For example, when a value of trisoup_enabled_flag is “0”, it may be defined that Trisoup is not used, and when a value of trisoup_enabled_flag is “1”, it may be defined that Trisoup is used.

The geometry information decoding unit 2010 may be configured to additionally decode the following syntax when Trisoup is used, that is, when the value of trisoup_enabled_flag is “1”.

Note that trisoup_enabled_flag may be included in the SPS 2001 instead of the GPS 2011.

The GPS 2011 may include a flag (trisoup_multilevel_enabled_flag) (first flag) that controls whether or not to enable Trisoup at a plurality of levels.

For example, when a value of trisoup_multilevel_enabled_flag is “0”, it may be defined that Trisoup at a plurality of levels is not enabled, that is, Trisoup at a single level is executed, and when a value of trisoup_multilevel_enabled_flag is “1”, it may be defined that Trisoup at a plurality of levels is enabled.

When the syntax is not included in the GPS 2011, the value of the syntax may be regarded as a value in a case where Trisoup at a single level is performed, that is, “0”.

Note that trisoup_multilevel_enabled_flag may be defined to be included in the SPS 2001 instead of the GPS 2011. In this case, when trisoup_multilevel_enabled_flag is not included in the SPS 2001, the value of the syntax may be regarded as a value in a case where Trisoup at a single level is executed, that is, “0”.

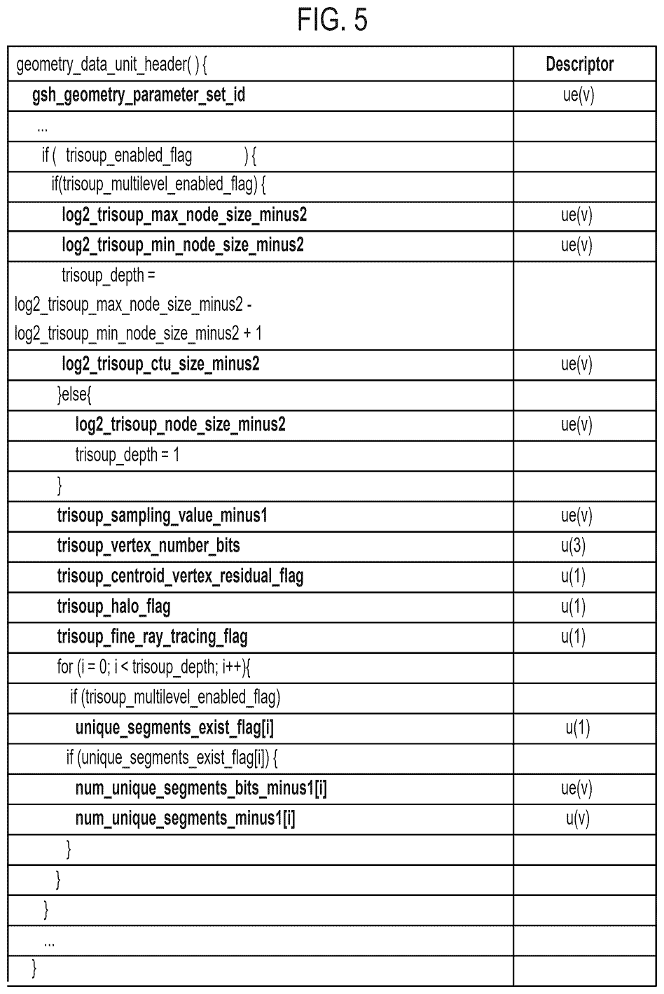

FIG. 5 illustrates an example of a syntax configuration of the GSH 2012. As described above, the GSH is also referred to as a geometry data unit header (GDUH).

The geometry information decoding unit 2010 may be configured to additionally decode the following syntax when Trisoup at a plurality of levels is enabled, that is, when the value of trisoup_multilevel_enabled_flag is “1”.

The GSH 2012 may include syntax (log 2_trisoup_max_node_size_minus2) that defines the maximum value of the Trisoup node size when Trisoup at a plurality of levels is enabled.

The syntax may be expressed as a value obtained by converting the maximum value of the actual Trisoup node size into a base-2 logarithm. Furthermore, the syntax may be expressed as a value obtained by converting the maximum value of the actual Trisoup node size into a base-2 logarithm and then subtracting 2.

The GSH 2012 may include syntax (log 2_trisoup_min_node_size_minus2) that defines the minimum value of the Trisoup node size when Trisoup at a plurality of levels is enabled.

The syntax may be expressed as a value obtained by converting the minimum value of the actual Trisoup node size into a base-2 logarithm. Furthermore, the syntax may be expressed as a value obtained by converting the actual Trisoup node size into a base-2 logarithm and then subtracting 2 from the result, in which the minimum value of the actual Trisoup node size is 4 (=2²).

In addition, the value of the syntax may be restricted to be necessarily 0 or more and log 2_trisoup_max_node_size_minus2 or less.

Furthermore, at this time, as illustrated in FIG. 5, trisoup_depth may be defined as trisoup_depth=log 2_trisoup_max_node_size_minus2−log 2_trisoup_min_node_size_minus2+1.

Instead of directly decoding a minimum Trisoup node size and a maximum Trisoup node size, depth values corresponding to the maximum Trisoup node size and the minimum Trisoup node size in an octree process described later may be decoded.

For example, in a case where a maximum depth (a depth at which all nodes have a size of 1×1×1) is 10, when it is desired to set the minimum Trisoup node size to 4 (=2²) and set the maximum Trisoup node size to 16 (=2⁴), 8 may be decoded as the depth value corresponding to the minimum Trisoup node size, and 6 may be decoded as the depth value corresponding to the maximum Trisoup node size.

The GSH 2012 may include syntax (log 2_trisoup_ctu_size_minus2) that defines a size of a node (hereinafter, referred to as a coding tree unit (CTU)) that decodes the Trisoup node size when Trisoup at a plurality of levels is enabled.

Such syntax may be expressed as a value obtained by conversion into a base-2 logarithm.

Moreover, such syntax may be expressed as a value obtained by converting the actual Trisoup node size into a base-2 logarithm and then subtracting 2 from the result, in which the minimum value of the actual Trisoup node size is 4 (=2²).

Further, the value of such syntax may be restricted to be necessarily a value equal to or larger than the maximum Trisoup node size.

Further, the value of such syntax may be expressed as a value obtained by subtracting a value obtained by converting the maximum Trisoup node size into a base-2 logarithm from a value obtained by converting a CTU size into a base-2 logarithm.

The geometry information decoding unit 2010 may be configured to additionally decode the following syntax when Trisoup at a plurality of levels is not enabled, that is, when the value of trisoup_multilevel_enabled_flag is “0”.

As described above, the geometry information decoding unit 2010 in the present embodiment may be configured to decode the maximum Trisoup node size and the minimum Trisoup node size, the maximum Trisoup node size being the maximum value of the node size at which Trisoup is applied, and the minimum Trisoup node size being the minimum value of the node side at which Trisoup is applied.

Furthermore, as described above, the geometry information decoding unit 2010 in the present embodiment may be configured to decode a predetermined size (CTU size) as a value equal to or larger than the maximum Trisoup node size.

With such a configuration, the node size can be selected between the maximum Trisoup node size and the minimum Trisoup node size for each region (CTU) of the predetermined size.

Furthermore, as described above, the geometry information decoding unit 2010 in the present embodiment may be configured to set the maximum Trisoup node size to a value of the predetermined size.

With such a configuration, the decoding of the CTU size can be omitted, so that a code amount and a processing amount can be reduced.

The GSH 2012 may include syntax (log 2_trisoup_node_sizeTrisoup_node_size_minus2) that defines the Trisoup node size when Trisoup at a plurality of levels is not enabled and when Trisoup is used.

Such syntax may be expressed as a value obtained by converting the actual Trisoup node size into a base-2 logarithm.

Furthermore, such syntax may be expressed as a value obtained by converting the actual Trisoup node size into a base-2 logarithm and then subtracting 2.

Furthermore, here, trisoup_depth may be defined as trisoup_depth=1 as illustrated in FIG. 5.

The GSH 2012 may include syntax (trisoup_sampling_value_minus1) that controls a sampling interval of reconfiguration points when Trisoup is used.

The GSH 2012 may include syntax (trisoup_vertex_number_bits) that specifies precision (bit number) of a vertex position of Trisoup described later. For example, in a case where the value of the syntax is 2, the vertex position is 2 bits, that is, the vertex position can have four types of values of 0, 1, 2, and 3.

Here, as described above, trisoup_vertex_number_bits may always transmit only one value regardless of a value of trisoup_depth, or the number to be decoded may be changed according to the value of trisoup_depth.

For example, trisoup_vertex_number_bits corresponding to each trisoup_depth may be decoded. In other words, the number of trisoup_vertex_number_bits decoded may be the same as the number of trisoup_depth. Specifically, for example, in a case where trisoup_depth is 2, two types of values of trisoup_vertex_number_bits may be transmitted.

The GSH 2012 may include a flag (trisoup_centroid_vertex_residual_flag) indicating whether or not to decode a residual of a centroid of a vertex of Trisoup described later. For example, in a case where a value of the flag is 1, the flag means that the residual of the centroid is to be decoded, and in a case where the value of the flag is 0, the flag means that the residual of the centroid is not to be decoded.

Here, as described above, trisoup_centroid_vertex_residual_flag may always transmit only one value regardless of the value of trisoup_depth, or the number to be decoded may be changed according to the value of trisoup_depth.

For example, trisoup_centroid_vertex_residual_flag corresponding to each trisoup_depth may be decoded. In other words, the number of trisoup_centroid_vertex_residual_flag decoded may be the same as the number of trisoup_depth. Specifically, for example, in a case where trisoup_depth is 2, two types of values of trisoup_centroid_vertex_residual_flag may be transmitted.

The GSH 2012 may include a flag (unique_segments_exist_flag[i]) indicating whether or not an unique segment exists in a target hierarchy for each hierarchy i (i=0, . . . , trisoup_depth-1) when Trisoup is used and when Trisoup at a plurality of levels is enabled.

For example, a value of unique_segments_exist_flag[i] of “1” means that at least one or more unique segments exist in the hierarchy i. A value of unique_segments_exist_flag[i] of “0” means that there is no unique segment in the hierarchy i.

The GSH 2012 may additionally include syntax (num_unique_segments_bits_minus1[i]) indicating the number of bits of syntax indicating the number of unique segments of the target hierarchy and syntax (num_unique_segments_minus1[i]) indicating the number of unique segments of the target hierarchy when a unique segment exists in the target hierarchy for each hierarchy i (i=0, . . . , trisoup_depth-1), that is, when a value of unique_segments_exist_flag[i] is “1”.

Here, for both num_unique_segments_bits_minus1[i] and num_unique_segments_minus1[i], a value obtained by subtracting “1” from the original value may be encoded as a value of the syntax.

### (Tree Synthesizing Unit 2020)

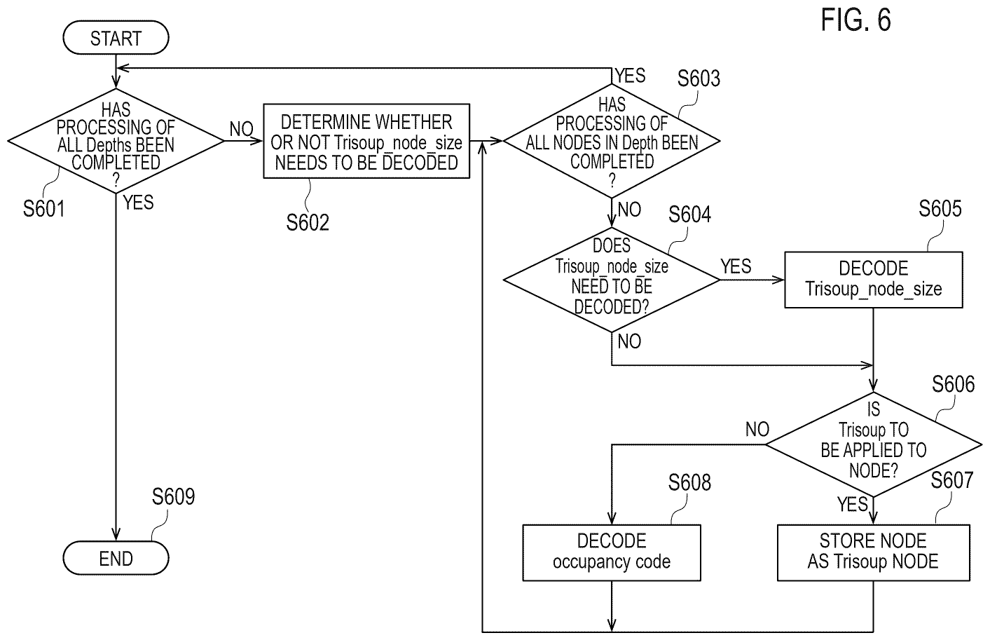

Hereinafter, processing in the tree synthesizing unit 2020 will be described with reference to FIG. 6. FIG. 6 is a flowchart illustrating an example of the process in the tree synthesizing unit 2020. Note that an example of synthesizing a tree using “octree” will be described below.

In step S601, the tree synthesizing unit 2020 confirms whether or not processing of all the depths has been completed. Note that the number of depths may be included as control data in the bit stream transmitted from the point cloud encoding device 100 to the point cloud decoding device 200.

The tree synthesizing unit 2020 calculates a node size of a target depth. In the case of “octree”, the node size of the first depth may be defined as “2 to the power of the number of depths”. That is, when the number of depths is N, the node size of the first depth may be defined as 2 to the power of N.

Furthermore, the node size of the second and subsequent depths may be defined by decreasing N one by one. That is, the node size of the second depth may be defined as “2 to the power of (N−1)”, the node size of the third depth may be defined as “2 to the power of (N−2)”, and the like.

Alternatively, since the node size is always defined by a power of 2, a value of the exponential part (N, N−1, N−2, or the like) may be simply considered as the node size. In the following description, the node size refers to a value of an exponential part of a length of one side of the node.

Note that, for simplicity, a case where a node shape is a cube, that is, a case where the lengths of all sides of the node are equal will be described below as an example.

When QtBt is used, that is, when the node shape is a cuboid and the length of each side of the node is different for each axis direction (x, y, and z), the length of the shortest side among the three directions may be considered as the node size. Similarly, the length of the longest side among the three directions may be considered as the node size.

Here, when the flag (trisoup_enabled_flag) for controlling whether or not to use Trisoup indicates that Trisoup is used, that is, when the value of trisoup_enabled_flag is “1”, the tree synthesizing unit 2020 may change the number of depths to be processed based on the value of the syntax (log 2_trisoup_min_node_size_minus2) that defines the minimum value of the Trisoup node size or the syntax (log 2_Trisoup_node_size_minus2) that defines the Trisoup node size. In such a case, for example, it may be defined as follows.

Number of depths to be processed=Total number of depths−(Minimum) Trisoup node size

Here, the minimum Trisoup node size can be defined by, for example, (log 2_trisoup_min_node_size_minus2+2). Similarly, the Trisoup node size can be defined by (log 2_Trisoup_node_size_minus2+2).

In this case, in a case where the processing of all the depths to be processed is completed, the tree synthesizing unit 2020 proceeds to step S609, and otherwise, the tree synthesizing unit 2020 proceeds to step S602.

In other words, in a case where (the number of depths to be processed−n)=0, the tree synthesizing unit 2020 proceeds to step S609, and in a case where (the number of depths to be processed−n)>0, the tree synthesizing unit 2020 proceeds to step S602.

Furthermore, the tree synthesizing unit 2020 may determine that Trisoup is applied to all the nodes having the node size (N−the number of depths to be processed) when proceeding to step S609.

In step S602, the tree synthesizing unit 2020 determines whether or not Trisoup_node_size described later needs to be decoded at the target depth.

For example, when “Trisoup at a plurality of levels is enabled (the value of trisoup_multilevel_enabled_flag is “1”)” and “the node size (N-n) of the target depth is equal to the CTU size”, the tree synthesizing unit 2020 may determine that “Trisoup_node_size needs to be decoded”.

In the present embodiment, a “node that decodes the Trisoup node size” is referred to as a coding tree unit (CTU). The term “CTU” is merely an example, and another term may be used as long as the term refers to the “node that decodes the Trisoup node size”.

Furthermore, in a case where the above-described condition is not satisfied, the tree synthesizing unit 2020 may determine that “Trisoup_node_size does not need to be decoded”.

Here, the maximum Trisoup node size can be defined by, for example, (log 2_trisoup_max_node_size_minus2+2).

Similarly, the minimum Trisoup node size can be defined by, for example, (log 2_trisoup_min_node_size_minus2+2).

When the above-described determination is completed, the tree synthesizing unit 2020 proceeds to step S603.

In step S603, the tree synthesizing unit 2020 determines whether or not the processing of all the nodes included in the target depth has been completed.

When the tree synthesizing unit 2020 determines that the processing of all the nodes of the target depth has been completed, the tree synthesizing unit 2020 proceeds to step S601 and performs processing of the next depth.

On the other hand, when the processing of all the nodes of the target depth has not been completed, the tree synthesizing unit 2020 proceeds to step S604.

In step S604, the tree synthesizing unit 2020 confirms whether or not Trisoup_node_size determined in step S602 needs to be decoded.

Note that step S602 may be omitted, and at a processing timing of step S604, the necessity of the decoding of Trisoup_node_size may be determined by a method similar to step S602.

When the tree synthesizing unit 2020 determines that Trisoup_node_size needs to be decoded, the tree synthesizing unit 2020 proceeds to step S605, and when the tree synthesizing unit 2020 determines that Trisoup_node_size does not need to be decoded, the tree synthesizing unit 2020 proceeds to step S606.

In step S605, the tree synthesizing unit 2020 decodes Trisoup_node_size.

Trisoup_node_size is information indicating a size of a descendant node at which Trisoup is to be applied, the descendant node being obtained by recursively dividing the CTU by octree or QtBt.

For example, in a case where the CTU size is 5 (=2⁵=32) and the decoded Trisoup_node_size is 2 (=2²=4), it may mean that Trisoup is to be applied to each node (node size 2) obtained by dividing the CTU by octree three times (=5−2).

The node size at which the decoded Trisoup is to be applied (hereinafter, referred to as a Trisoup node size) is stored as additional information of the node. Note that an initial value of the Trisoup node size may be set to 0 (=2°=1), and may be overwritten with a value decoded in step S605.

The tree synthesizing unit 2020 decodes Trisoup_node_size, and then proceeds to step S606.

In step S606, the tree synthesizing unit 2020 confirms the value of the Trisoup node size stored as internal information of the node.

In a case where Trisoup is applied to a target node, that is, in a case where the size of the node is equal to the Trisoup node size stored as the internal information of the node, the tree synthesizing unit 2020 proceeds to step S607.

In a case where Trisoup is not applied to the target node, that is, in a case where the size of the node is different from the Trisoup node size stored as the internal information of the node, the tree synthesizing unit 2020 proceeds to step S608.

In step S607, the tree synthesizing unit 2020 stores the target node as a node to which Trisoup is to be applied, that is, a Trisoup node. No further node division by “octree” is to be applied to the target node. Thereafter, the tree synthesizing unit 2020 proceeds to step S603 and proceeds to processing of the next node.

In step S608, the tree synthesizing unit 2020 decodes information called the occupancy code.

In the case of “octree”, the occupancy code is information indicating whether or not a point to be decoded is included in each child node when the target node is divided into eight nodes (referred to as child nodes) by dividing the target node in half in each of x-, y-, and z-axis directions.

For example, the occupancy code may be defined in such a way that information of one bit is allocated to each child node, and when the information of one bit is “1”, the point to be decoded is included in the child node, and when the information of one bit is “0”, the point to be decoded is not included in the child node.

When decoding such an occupancy code, the tree synthesizing unit 2020 may estimate in advance a probability that the point to be decoded is present in each child node, and perform entropy decoding on a bit corresponding to each child node based on the probability.

Furthermore, in step S608, the tree synthesizing unit 2020 may store the position information of the node to which Trisoup is not applied in a one-dimensional array or the like for each depth for use in S901 described later.

Specifically, the tree synthesizing unit 2020 may store the position information of the target node (a node before division) in step S608. For example, the tree synthesizing unit 2020 may store coordinate values of a point closest to the origin among vertices of the target node (cuboid) in a one-dimensional array for each depth, and such information may be used by the approximate-surface synthesizing unit 2030 described later.

In a case where the size (the lengths of the sides in the x-axis direction, the y-axis direction, and the z-axis direction) of the cuboid is determined for each depth, if the coordinate values of the point closest to the origin in the node and the depth can be specified as described above, the position information of the node can be restored.

Similarly, the point cloud encoding device 100 may perform entropy coding.

In step S608, the Trisoup node size stored as the internal information of the node may be stored as internal information of each child node of the node. In other words, the Trisoup node size may be inherited by the child node. As a result, the value of the Trisoup node size decoded in step S605 can be propagated to the descendant node.

### (Approximate-Surface Synthesizing Unit 2030)

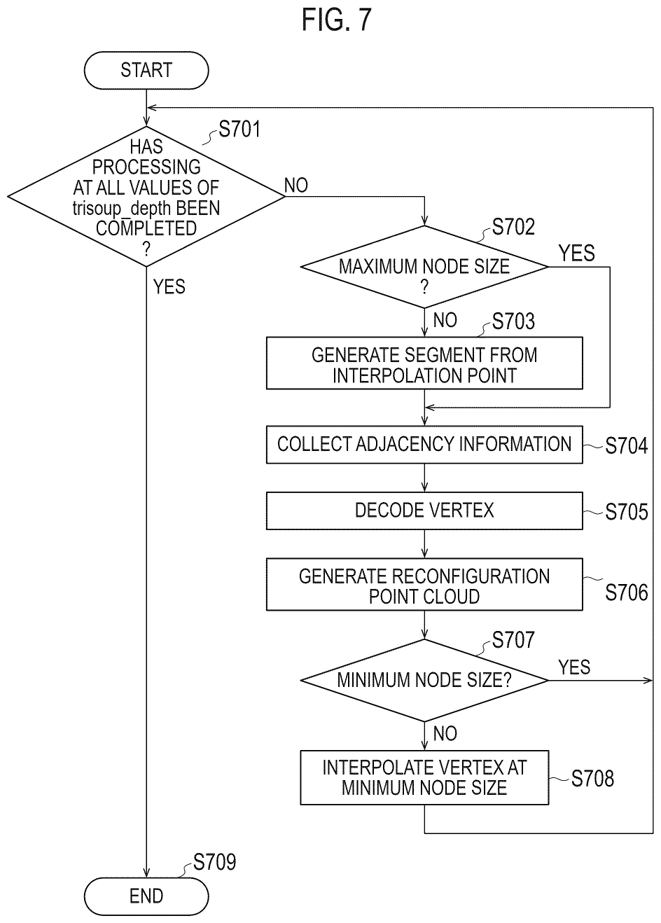

Hereinafter, an example of processing in the approximate-surface synthesizing unit 2030 will be described with reference to FIGS. 7 to 25.

FIG. 7 is a flowchart illustrating an example of the process in the approximate-surface synthesizing unit 2030.

As illustrated in FIG. 7, in step S701, the approximate-surface synthesizing unit 2030 determines whether or not processing at all values of trisoup_depth has been completed.

In a case where the processing has been completed for all values of trisoup_depth, the approximate-surface synthesizing unit 2030 proceeds to step S709 and terminates the processing. In a case where the processing of all values of trisoup_depth has not been completed, the approximate-surface synthesizing unit 2030 proceeds to step S702.

In step S702, the approximate-surface synthesizing unit 2030 determines whether or not the Trisoup node size corresponding to trisoup_depth is equal to the maximum Trisoup node size.

When the Trisoup node size corresponding to trisoup_depth is equal to the maximum Trisoup node size, the approximate-surface synthesizing unit 2030 proceeds to step S704, and when the Trisoup node size corresponding to trisoup_depth is not equal to the maximum Trisoup node size, that is, when the Trisoup node size corresponding to the trisoup_depth is smaller than the maximum Trisoup node size, the approximate-surface synthesizing unit 2030 proceeds to step S703.

In step S702, the approximate-surface synthesizing unit 2030 acquires and integrates vertex positions for each node.

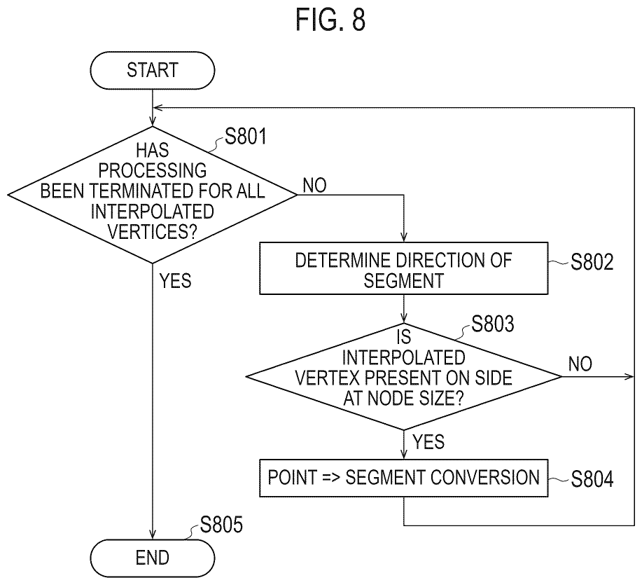

In step S703, the approximate-surface synthesizing unit 2030 generates a segment corresponding to an “interpolated vertex (a vertex on which an interpolation process has been performed)” generated in step S708 to be described later. FIG. 8 is a flowchart illustrating an example of the processing of step S703.

Hereinafter, an example of the processing of step S703 will be described with reference to FIG. 8.

As illustrated in FIG. 8, in step S801, the approximate-surface synthesizing unit 2030 determines whether or not the processing has been completed for all the “interpolated vertices” generated in step S708 to be described later.

In a case where the processing has been completed, the approximate-surface synthesizing unit 2030 proceeds to step S805, and terminates the processing. If the processing has not been completed, the approximate-surface synthesizing unit 2030 proceeds to step S802 to perform the processing on the next “interpolated vertex”.

In step S802, the approximate-surface synthesizing unit 2030 determines on which segment in a direction (any of x, y, and z directions) the “interpolated vertex” is present.

For example, as will be described later, in a case where the segment and the vertex of Trisoup are present at positions shifted by 0.5 from integer coordinate positions, in the segment in the x direction, only an x coordinate of the “interpolated vertex” has an integer value (x.0), and a y coordinate and a z coordinate thereof have decimal values (x.5).

Similarly, the segment in the y direction, only a y coordinate has an integer value, and in the segment in the z direction, only a z coordinate has an integer value. Therefore, the approximate-surface synthesizing unit 2030 can determine the direction of the segment in which the “interpolated vertex” is to be present by confirming in which axis direction the coordinate has an integer value.

Note that, in a case where the coordinate value is stored in an integer format, for example, in a case where the true coordinate value is doubled and then held as an integer value in order to represent 0.5, the approximate-surface synthesizing unit 2030 can determine whether the coordinate value is an integer or a decimal number (x.5) based on whether or not the least significant bit of the coordinate value in each axis direction is 1.

The approximate-surface synthesizing unit 2030 stores a result of the determination performed in this manner, and proceeds to the next step S803.

In step S803, the approximate-surface synthesizing unit 2030 determines whether or not the “interpolated vertex” is present on a side at the current Trisoup node size. For example, the approximate-surface synthesizing unit 2030 can perform such determination by the following method.

(1) First, the approximate-surface synthesizing unit 2030 quantizes coordinate values of the “interpolated vertex” on the x, y, and z axes into integers.

Specifically, the approximate-surface synthesizing unit 2030 adds 0.5 to each coordinate value and then truncates the fractional part.

Here, in a case where the coordinate value is stored as an integer value that is twice the true value, the approximate-surface synthesizing unit 2030 adds 1, then divides the coordinate value by 2, and truncates the fractional part.

Alternatively, in a case where the coordinate value is stored as an integer value that is twice the true value, the approximate-surface synthesizing unit 2030 adds 1 and then shifts the coordinate value to the right by 1 bit.

Note that, although a case where the coordinate values are converted into integers in all of the x-axis direction, the y-axis direction, and the z-axis direction has been described here, the approximate-surface synthesizing unit 2030 may convert only coordinate values on axes other than the “direction” determined in step S802 into integers.

For example, in a case where the above-described “direction” is the x axis, the approximate-surface synthesizing unit 2030 is only required to convert only the y coordinate and the z coordinate into integers.

(2) Secondly, the approximate-surface synthesizing unit 2030 confirms whether or not each of the coordinate values on the axes other than the “direction” after being converted into integers, which are determined in step S802, is a multiple of the Trisoup node size.

For example, in a case where the above-described “direction” is the x-axis direction and the value of the Trisoup node size is 8 (=23), the approximate-surface synthesizing unit 2030 confirms whether or not each of the y coordinate and the z coordinate, which are converted into integers, is a multiple of 8.

In the processing of (2) described above, in a case where all the coordinate values on the axes other than the “direction” after being converted into integers are multiples of the Trisoup node size, the approximate-surface synthesizing unit 2030 determines that the “interpolated vertex” is present on the side at the current Trisoup node size, and proceeds to step S804.

Otherwise, that is, in a case where the coordinate value in at least one axis direction is not a multiple of the Trisoup node size, the approximate-surface synthesizing unit 2030 determines that the “interpolated vertex” is not present on the side at the current Trisoup node size, proceeds to step S801, and proceeds to processing of the next “interpolated vertex”.

In step S804, the approximate-surface synthesizing unit 2030 generates a segment corresponding to the “interpolated vertex” by using the coordinates of the “interpolated vertex”, which are converted into integers in step S803.

Here, the segment may include three elements: coordinates (x,y,z) of a start point, coordinates (x,y,z) of an end point, and a vertex position on the segment (0 to Trisoup node size−1).

The above-described start point is obtained, for example, by quantizing the coordinate values of the “interpolated vertex” converted into integers with the Trisoup node size.

Specifically, for example, when a value obtained by taking a base-2 logarithm as the Trisoup node size is TrisoupNodeSizeLog 2, the coordinate values of the “interpolated vertex” can be derived by performing the following computation.

Quantized coordinate value=(Coordinate value>>TrisoupNodeSizeLog 2)<<TrisoupNodeSizeLog 2

Here, >> means a right bit shift, and << means a left bit shift.

In the case of proceeding to the processing of step S804, it is already clear that the coordinate values on the axes other than the “direction”, which are determined in step S802, are multiples of the Trisoup node size. Therefore, in step S804, the approximate-surface synthesizing unit 2030 may perform the above-described quantization process only on the coordinate value on the axis corresponding to the “direction” determined in step S802.

Next, the coordinates of the end point can be calculated by adding the value of the Trisoup node size to the coordinate value on the axis corresponding to the “direction” determined in step S802 with respect to the coordinates of the start point.

Finally, the vertex position on the segment can be derived by subtracting the coordinate value of the start point on the axis corresponding to the above-described “direction” from the coordinate value of the “interpolated vertex” on the axis corresponding to the “direction” determined in step S802.

After the above processing is performed, the present operation proceeds to step S801, and proceeds to the processing of the next “interpolated vertex”.

Although an example in which the segment is generated from the “interpolated vertex” has been described above, data may be held in the form of the “presence or absence of the interpolated vertex” and the “position of the interpolated vertex” for each unique segment instead of the segment.

For example, the “presence or absence of the interpolated vertex” for each unique segment can be determined as “with vertex” if there is a segment in which the coordinates of the start point and the coordinates of the end point of each unique segment are the same among the segments generated by the above-described method, and the “presence or absence of the interpolated vertex” for each unique segment can be determined as “without vertex” if there is no segment in which the coordinates of the start point and the coordinates of the end point of each unique segment are the same among the segments generated by the above-described method.

Furthermore, as the “position of the interpolated vertex”, as described above, a vertex position held by the segment in a case where the “presence or absence of the interpolated vertex” for each unique segment is determined as “with vertex” can be used as it is.

As described above, the approximate-surface synthesizing unit 2030 generates the segment (alternatively, the “presence or absence of the interpolated vertex” and the “position of the interpolated vertex”) based on the “interpolated vertex” in step S703 of FIG. 8, and then proceeds to step S704.

In step S704, the approximate-surface synthesizing unit 2030 collects adjacency information to be used for decoding the vertex in the next step S705.

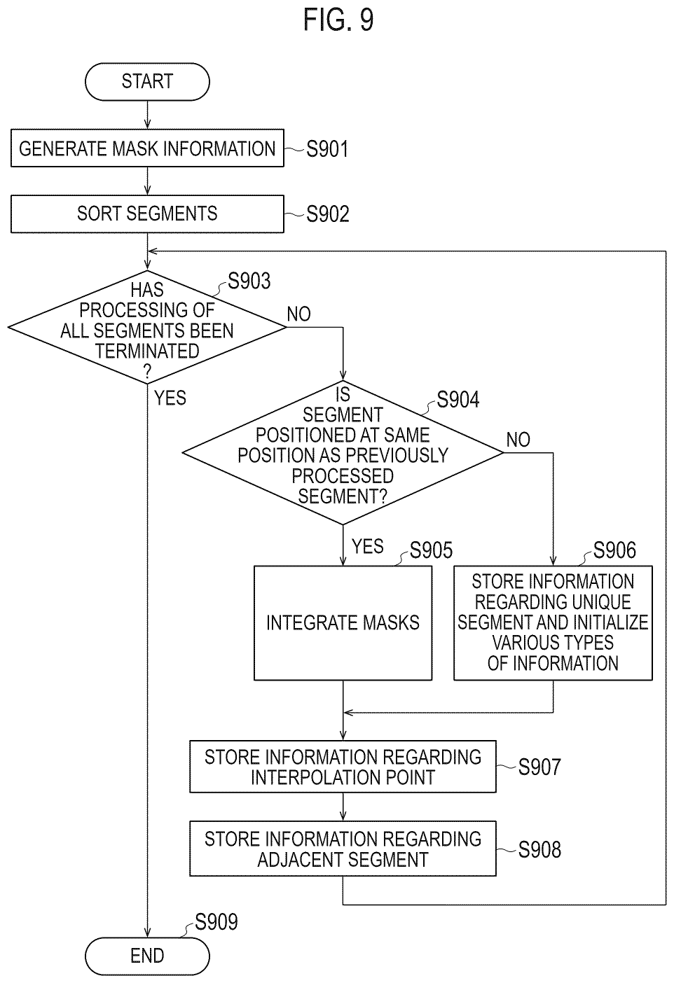

FIG. 9 is a flowchart illustrating an example of the processing of step S704. Next, an example of the processing of step S704 will be described with reference to FIG. 9.

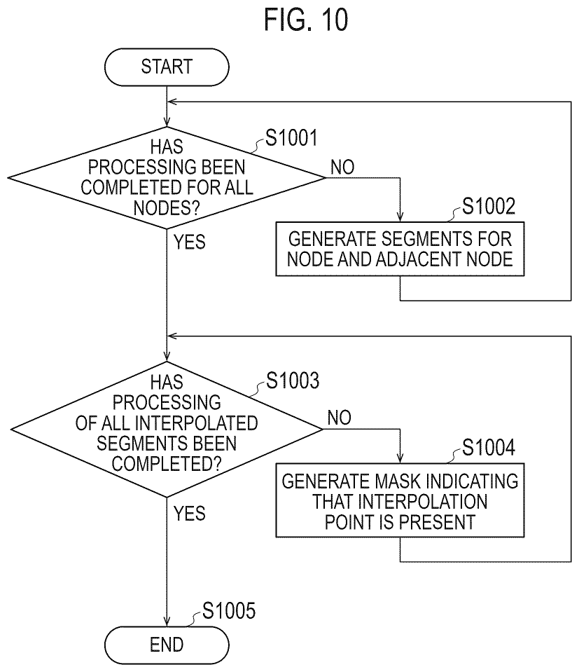

As illustrated in FIG. 9, in step S901, the approximate-surface synthesizing unit 2030 generates mask information. FIG. 10 illustrates a specific example of a method of generating the mask information.

In the case of generating the mask information, as illustrated in FIG. 10, in step S1001, the approximate-surface synthesizing unit 2030 determines whether or not the processing has been completed for all the Trisoup nodes at the Trisoup node size.

In a case where the processing has been completed, the present operation proceeds to step S1003, and in a case where the processing has not been completed, the present operation proceeds to step S1002.

In step S1002, the approximate-surface synthesizing unit 2030 generates 36 segments and mask values respectively corresponding to the segments for the Trisoup node.

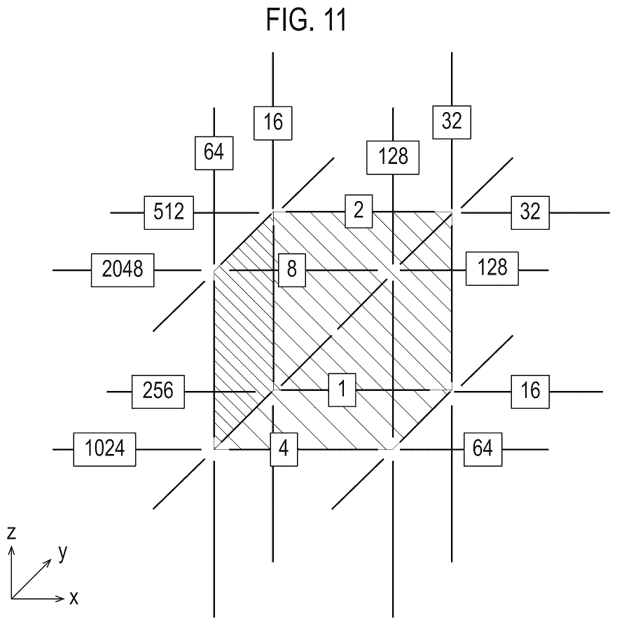

FIG. 11 illustrates an example of the generation of the segment and the mask value. A shaded portion in FIG. 11 indicates an example of the Trisoup node, each line segment indicates an example of the segment, and the number described on the segment indicates an example of the mask value.

Note that, since it is difficult to describe an example of the mask value for all the segments, the example of the mask value is described only for some segments, but actually, the mask value is set for all the segments as follows.

First, for the segment, the approximate-surface synthesizing unit 2030 generates four segments at each of 12 sides of the Trisoup node, an adjacent position having a larger coordinate value than the node in each of the x direction, the y direction, and the z direction, and an adjacent position having a smaller coordinate value than the node in each of the x direction, the y direction, and the z direction, and generates a total of 36 segments as illustrated in FIG. 11.

Here, each segment has information regarding the start point and the end point, and no vertex is present, and thus information regarding the vertex position is not held.

Next, a setting example of the mask value of each segment will be described.

The approximate-surface synthesizing unit 2030 sets the mask value in which only any one bit of lower 4 bits of the mask value is 1 and the other bits are 0 for the segments corresponding to 12 sides of the Trisoup node.

For example, as illustrated in FIG. 11, the approximate-surface synthesizing unit 2030 may set mask values of 1, 2, 4, and 8 for the segment in the x-axis direction.

Similarly, the approximate-surface synthesizing unit 2030 may set mask values of 1+(1<<13), 2+(1<<13), 4+(1<<13), and 8+(1<<13) for the segment in the y-axis direction.

Similarly, the approximate-surface synthesizing unit 2030 may set mask values of 1+(1<<14), 2+(1<<14), 4+(1<<14), and 8+(1<<14) for the segment in the z-axis direction.

In a case where such setting is made, when any of the first to fourth bits of the mask value is 1, it can be determined that a node corresponding to the corresponding segment is the Trisoup node.

Next, as illustrated in FIG. 11, the approximate-surface synthesizing unit 2030 may set mask values of 16, 32, 64, and 128 for the segments (12 segments including four segments in the x direction, four segments in the y direction, and four segments in the z direction) corresponding to an adjacent node in a direction in which coordinate values of the node become larger than those of the Trisoup node in the x direction, the y direction, and the z direction, respectively.

In a case where such setting is made, when any of the fifth to eighth bits of the mask value is 1, it can be determined that an adjacent node whose coordinate values become smaller for the segments is the Trisoup node.

Next, as illustrated in FIG. 11, the approximate-surface synthesizing unit 2030 may set mask values of 256, 512, 1024, and 2048 for the segments (12 segments including four segments in the x direction, four segments in the y direction, and four segments in the z direction) corresponding to an adjacent node in a direction in which coordinate values of the node become smaller than those of the Trisoup node in the x direction, the y direction, and the z direction, respectively.

In a case where such setting is made, when any of the ninth to twelfth bits of the mask value is 1, it can be determined that an adjacent node whose coordinate values become larger for the segments is the Trisoup node.

As described above, after generating the segment and the mask value corresponding thereto, the approximate-surface synthesizing unit 2030 proceeds to step S1001 and proceeds to the processing of the next Trisoup node.

Here, a node to which Trisoup is not applied at the depth and which is stored in step S608 described above may be added as a node to be processed in step S1001.

Trisoup is not applied to the “node to which Trisoup is not applied at the depth” at the depth. Therefore, the vertex of Trisoup or the like is not generated in the node itself, but the node is a region in which Trisoup is to be applied at a depth larger than the depth. Therefore, when generating the mask of “the node to which Trisoup is not applied at the depth” in step S1002, a mask in which “any one of the first to fourth bits of the mask value is 1” is not set, and only a mask in which “any one of the fifth to eighth bits of the mask value is 1” and a mask in which “any one of the ninth to twelfth bits of the mask value is 1” are set.

In step S1003, the approximate-surface synthesizing unit 2030 determines whether or not the processing of all the segments has been completed for the segment corresponding to the “interpolated vertex” generated in step S703.

In a case where the processing has been completed, the present operation proceeds to step S1005, and the mask generation processing of step S901 is terminated. In a case where the processing has not been completed, the present operation proceeds to step S1004.

In step S1004, the approximate-surface synthesizing unit 2030 generates a mask value indicating that the “interpolated vertex” is present in the segment for the segment corresponding to the “interpolated vertex”.

The approximate-surface synthesizing unit 2030 may set, for example, a value of 1<<15 for the mask value. In a case where such a value is set, when the sixteenth bit of the mask value is 1, it can be determined that the “interpolated vertex” is present in the segment.

After generating the mask value, the approximate-surface synthesizing unit 2030 proceeds to step S1003 and proceeds to the processing of the next segment.

Each of the mask values generated in steps S1002 and S1004 is a value of a power of 2. In this way, when the mask values of the segments present at the same position are combined in step S905 to be described later, the mask values can be easily combined by performing a bitwise operation (logical sum).

Furthermore, as described above, information (whether or not the node is the Trisoup node, whether or not the Trisoup node is present adjacent to the node, whether or not the “interpolated vertex” is present in the segment, or the like) regarding the segment can be obtained depending on whether each bit of the mask values combined in this manner is 1 or 0.

After generating the mask information as described above, the approximate-surface synthesizing unit 2030 proceeds to step S902.

In step S902, the approximate-surface synthesizing unit 2030 collects and then sorts all the segments generated in step S901 and the segment corresponding to the “interpolated vertex”.

The approximate-surface synthesizing unit 2030 sorts the segments based on start point coordinates and end point coordinates of each segment, for example. By performing such a process, the segments having the same start point and end point can be sorted so as to be consecutive.

After the sorting is completed, the approximate-surface synthesizing unit 2030 proceeds to step S903.

In step S903, the approximate-surface synthesizing unit 2030 determines whether or not the processing of all the segments has been completed for the segments sorted in step S902.

In a case where the processing has been completed, the present operation proceeds to step S909, and the processing of collecting the adjacency information in step S704 is terminated. In a case where the processing has not been completed, the present operation proceeds to step S904.

In step S904, the approximate-surface synthesizing unit 2030 determines whether or not the segment is positioned at the same position as the previously processed segment.

Specifically, for example, the approximate-surface synthesizing unit 2030 determines whether or not both the coordinates of the start point and the coordinates of the end point of the segment are the same as those of the previously processed segment.

In a case where the current position is the same as that of the previously processed segment, the present operation proceeds to step S905. In a case where the current position is not the same as the position of the previously processed segment, the present operation proceeds to step S906.

In step S905, the approximate-surface synthesizing unit 2030 integrates the mask value corresponding to the segment generated in step S901 and the mask value of each previously processed segment at the same position.

For example, in a case where the mask value corresponding to each segment is defined by a power of 2 as described in step S901, the approximate-surface synthesizing unit 2030 can integrate the masks by taking a logical sum of the mask values of the respective segments.

After integrating the masks, the approximate-surface synthesizing unit 2030 proceeds to step S907.

In step S906, the approximate-surface synthesizing unit 2030 stores the previously processed segment before the segment as a unique segment in a case where a predetermined condition A is satisfied.

For example, the predetermined condition A may be a condition that the previously processed segment is a segment corresponding to the Trisoup node.

For example, in a case where at least any one bit of the lower 4 bits of the mask value obtained by integration in step S905 is 1, it can be seen that the previously processed segment is a segment corresponding to the Trisoup node.

The approximate-surface synthesizing unit 2030 may store, as information regarding the unique segment, for example, each of coordinates of a start point, coordinates of an end point, information regarding an interpolation point described in step S907 described later, information regarding an adjacent segment described in step S908 described later, and the mask value obtained by integration in step S905 for the unique segment (target unique segment). Such pieces of information are used in the vertex decoding processing of step S705.

After storing the information regarding the unique segment, the approximate-surface synthesizing unit 2030 initializes various types of information (interpolation point information, adjacent segment information, integrated mask value, and the like).

In a case where the predetermined condition is not satisfied, the approximate-surface synthesizing unit 2030 performs only the initialization. After the above processing is completed, the present operation proceeds to step S907.

In step S907, in a case where a predetermined condition B is satisfied, the approximate-surface synthesizing unit 2030 stores the information regarding the interpolation point.

For example, the predetermined condition B may be a condition that the mask value of the segment indicates that the “interpolated vertex” is present in the segment. Specifically, for example, the predetermined condition B may be a condition that the sixteenth bit of the mask value is 1.

In a case where the predetermined condition B is satisfied, the approximate-surface synthesizing unit 2030 stores the coordinates of the “interpolated vertex”. Specifically, the approximate-surface synthesizing unit 2030 stores the value of the “vertex position on the segment” generated in step S804. The value stored here is stored as the information regarding the unique segment in step S906.

In a case where the approximate-surface synthesizing unit 2030 does not determine in step S906 that the segment is the unique segment (in a case where the predetermined condition A in step S906 is not satisfied), the information regarding the interpolation point of the segment stored in step S907 is discarded.

Note that the approximate-surface synthesizing unit 2030 may separately prepare an array for storing the values of the “vertex position on the segment”, and in the present step, store an index value for specifying a value corresponding to the segment in the array instead of the coordinate value itself.

After the above processing is completed, the present operation proceeds to step S908.

In step S908, the approximate-surface synthesizing unit 2030 stores the information regarding the adjacent segment.

Specifically, for example, the approximate-surface synthesizing unit 2030 stores information (for example, an index of a segment) for specifying a segment whose start point coordinates or end point coordinates are the same as the start point coordinates of the segment.

For example, as for the segment whose start point coordinates or end point coordinates are the same as the start point coordinates of the segment, specifically, there is one segment whose end point coordinates are the same as the start point coordinates of the segment in the same axis direction as the segment, and there are four segments in an axis direction orthogonal to the segment. The information stored here is stored as the information regarding the unique segment in step S906.

In a case where the approximate-surface synthesizing unit 2030 does not determine that the segment is a unique segment in step S906 (in a case where the predetermined condition A in step S906 is not satisfied), the information regarding the adjacent segment of the segment generated in step S908 is discarded.

After the above-described processing is completed, the present operation proceeds to step S903, and proceeds to processing of the next segment.

As described above, the approximate-surface synthesizing unit 2030 collects the adjacency information in step S704, and then proceeds to step S705.

In step S705, the approximate-surface synthesizing unit 2030 decodes the vertex of Trisoup at the value of trisoup_depth.

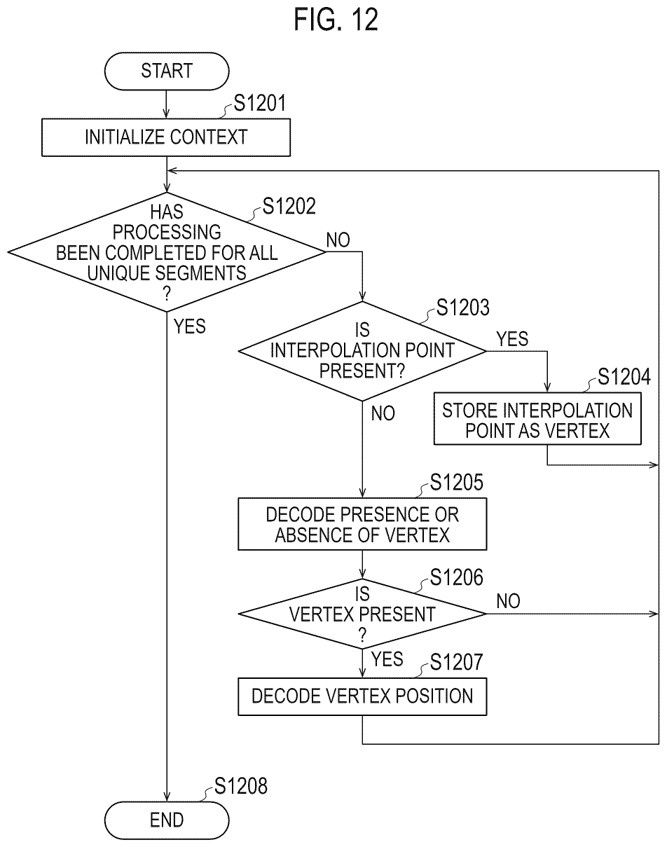

FIG. 12 is a flowchart illustrating an example of the vertex decoding method in step S705. Hereinafter, an example of the processing of step S705 will be described with reference to FIG. 12.

As illustrated in FIG. 12, in step S1201, the approximate-surface synthesizing unit 2030 initializes a context.

Here, the initialization refers to, for example, setting an initial value of a probability distribution when entropy decoding is performed on information corresponding to the context. Encoding efficiency can be improved by updating the probability distribution for each context based on an entropy-decoded value.

Note that the approximate-surface synthesizing unit 2030 may prepare a plurality of sets of contexts and initialize each context according to application thereof.

For example, the approximate-surface synthesizing unit 2030 may include a total of three types of contexts including a context for decoding the presence or absence of the vertex, a context for decoding the first bit of the vertex position, and a context for decoding the second bit of the vertex position, as described later, for each application.

Such contexts may include two elements, CtxMap1 and CtxMap2, as described later. For example, in Reference 2 (“[GPPC][13.50] Report on enhanced edge neighborhood for vertex prediction in TriSoup, ISO/IEC JTC1/SC29/WG7 m61565”), the context for decoding the presence or absence of the vertex is provided as MapOBUFTrisoup[0], the context for decoding the first bit of the vertex position is provided as MapOBUFTrisoup[1], and the context for decoding the second bit of the vertex position is provided as MapOBUFTrisoup[2].

Further, in Reference 2, the context of CtxMap1 of MapOBUFTrisoup[0] is prepared for 7 bits (=128), the context of CtxMap2 is prepared for 15 bits (14+1 bits), and each context is initialized.

Similarly, CtxMap1 of MapOBUFTrisoup[1] is prepared for 6 bits, CtxMap2 is prepared for 15 bits (10+1+3+1 bits), CtxMap1 of MapOBUFTrisoup[2] is prepared for 7 bits (6+1 bits), CtxMap2 is prepared for 15 bits (10+1+3+1 bits), and initialization is performed.

As described later, CtxMap1 of the context for decoding the presence or absence of the vertex has a value corresponding to 7 bits, and CtxMap2 has a value corresponding to 15 bits.

Similarly, CtxMap1 of the first bit of the vertex position has a value corresponding to 6 bits, CtxMap2 has a value corresponding to 11 bits, CtxMap1 of the first bit of the vertex position has a value corresponding to 7 bits, and CtxMap2 has a value corresponding to 15 bits. At this time, as in Reference 2 described above, if a context whose value is equal to or larger than the number of bits to be actually used is prepared in advance, the subsequent processing can be performed.

Furthermore, by preparing only the minimum necessary context based on bits to be actually used, it is possible to reduce a memory amount related to the storage of the context.

In the example described later, CtxMap2 of the first bit of the vertex position has only a value corresponding to 11 bits, and thus, a context corresponding to 11 bits may be prepared and initialized. In other words, it is not necessary to prepare a value corresponding to 15 bits as in Reference 2.

After the context initialization is completed, the present operation proceeds to step S1202.

In step S1202, the approximate-surface synthesizing unit 2030 determines whether or not the processing has been completed for all the unique segments generated in step S703.

In a case where the processing has been completed for all the unique segments, the present operation proceeds to step S1208, and the processing of step S703 is terminated. In a case where the processing has not been completed for all the unique segments, the present operation proceeds to step S1203.

In step S1203, the approximate-surface synthesizing unit 2030 determines whether or not the “interpolated vertex” is present in the unique segment.

Whether or not the “interpolated vertex” is present can be determined based on the integrated mask value stored in step S906 or the information regarding the “presence or absence of the interpolated vertex” generated in step S703. In a case where the “interpolated vertex” is present, the present operation proceeds to step S1204. In a case where the “interpolated vertex” is not present, the present operation proceeds to step S1205.

In step S1204, the approximate-surface synthesizing unit 2030 stores the “vertex position on the segment” stored in step S906 or the “position of the interpolated vertex” generated in step S703 as the vertex position in the unique segment.

In other words, the approximate-surface synthesizing unit 2030 sets the “vertex position on the segment” stored in step S906 as a decoded value of the vertex position in the unique segment.

Further, the approximate-surface synthesizing unit 2030 sets the decoded value of the “presence or absence of the vertex” in the unique segment as “with vertex”.

That is, step S1204 is processing of implicitly determining the information indicating the vertex position and the presence or absence of the vertex by using an interpolated value instead of decoding the information indicating the vertex position and the presence or absence of the vertex from the bit stream.

After the above-described processing is completed, the present operation proceeds to step S1202, and proceeds to processing of the next unique segment.

In step S1205, the approximate-surface synthesizing unit 2030 decodes, from the bit stream, the information indicating the presence or absence of the vertex, which indicates whether or not the vertex is present in the unique segment.

The information indicating the presence or absence of the vertex is a 1-bit flag, and may be entropy-coded in the point cloud encoding device 100. The approximate-surface synthesizing unit 2030 may prepare a plurality of probability models at the time of entropy coding (encoding device)/decoding (decoding device) and select a probability model according to the context. The context may be set, for example, based on the mask value stored and integrated in step S906.

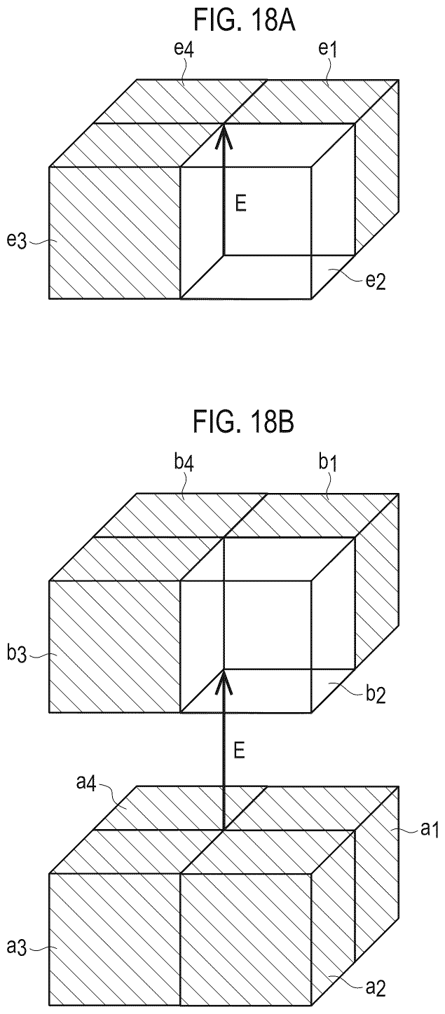

An example of a context setting method will be described below with reference to FIGS. 18 to 20.

FIGS. 18A and 18B illustrate neighboring nodes when the unique segment is E. A direction of an arrow E means a direction away from the origin (a direction in which the coordinate value increases).

Nodes e1 to e4 are nodes adjacent to the unique segment (including the unique segment as a side).

Whether the nodes e1 to e4 are present can be determined based on whether each of the first to fourth bits of the mask value of the unique segment generated in step S704 is 1 or 0, respectively.

Nodes a1 to a4 are nodes (including as a side) adjacent to a segment that is adjacent to the unique segment in a direction close to the origin (a direction in which the coordinate value decreases).

Whether or not the nodes a1 to a4 are present can be determined based on whether each of the fifth to eighth bits of the mask value of the unique segment generated in step S704 is 1 or 0.

Nodes b1 to b4 are nodes (included as a side) adjacent to a segment adjacent to the unique segment in a direction far from the origin (a direction in which the coordinate value increases).

Whether or not the nodes b1 to b4 are present can be determined based on whether each of the ninth to twelfth bits of the mask value of the unique segment generated in step S704 is 1 or 0.

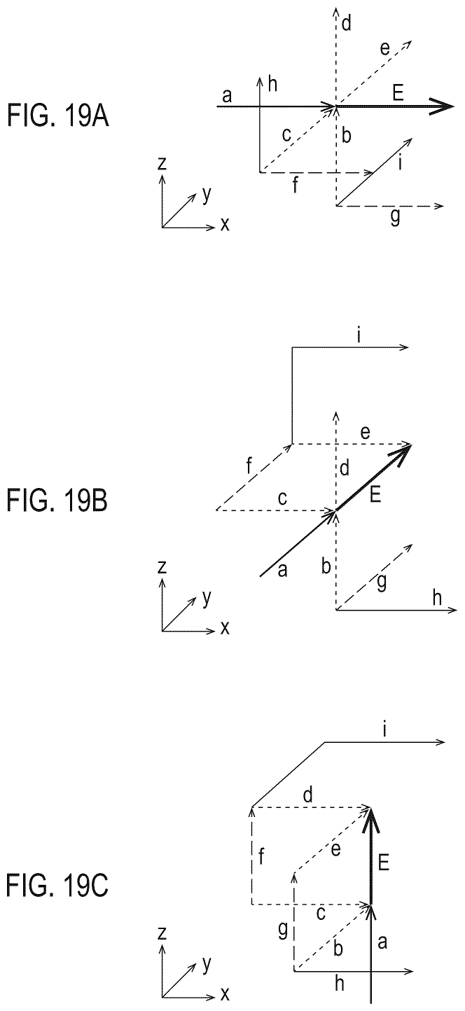

In FIGS. 19A to 19C, edges of the neighboring nodes illustrated in FIGS. 18A and 18B are numbered.

As illustrated in FIGS. 19A to 19C, the arrangement varies depending on whether a direction of the unique segment E is the x-axis direction, the y-axis direction, or the z-axis direction. When the unique segment is decoded in the order of raster scan (also referred to as a lexicographic order, in which the coordinate values are sorted in ascending order according to a priority order of x, y, and z), only edges (segments) that have been decoded before the unique segment are included.

A direction of an arrow of each segment in FIGS. 19A to 19C indicates a direction away from the origin (a direction in which the coordinate value increases).

The context may include CtxMap1 (or primary Information) and CtxMap2 (secondary information).

CtxMap1 may be configured as follows, for example.

CtxMap1=min(nclosestPattern,2)×15×2+(neighbEdge−1)×2+(ctx1==4?1:0)

Here, min(A,B) is a function that returns the smaller value of two variables A and B.

Furthermore, nclosestPattern represents the number of edges whose vertices are present at positions close to the unique segment E (positions where a distance from the unique segment is equal to or shorter than an edge length/2) among edges (unique segment) with suffixes of a to e illustrated in FIGS. 19A to 19C, and has a value of 0 to 4.

That is, min(nclosestPattern,2) is any one of three types of integer values of 0 to 2.

neighbEdge is a 4-bit binary number, and represents whether or not each of the nodes e1 to e4 of FIG. 18A is present by 1 bit. neighbEdge has any one of integer values of 1 to 15 when considered as a decimal number.

ctx1 represents the number of nodes that are present among the nodes a1 to a4 in FIG. 18B.

(CONDITION ? A: B) is a ternary operator, and returns a value of A when the condition is satisfied, and returns a value of B when the condition is not satisfied. In the above case, if the value of ctx1 is 4, 1 is returned, otherwise, 0 is returned.

As described above, CtxMap1 can have 3×15×2=90 (<27) values. In other words, CtxMap1 can represent all the values that can be taken as a 7-bit binary number.

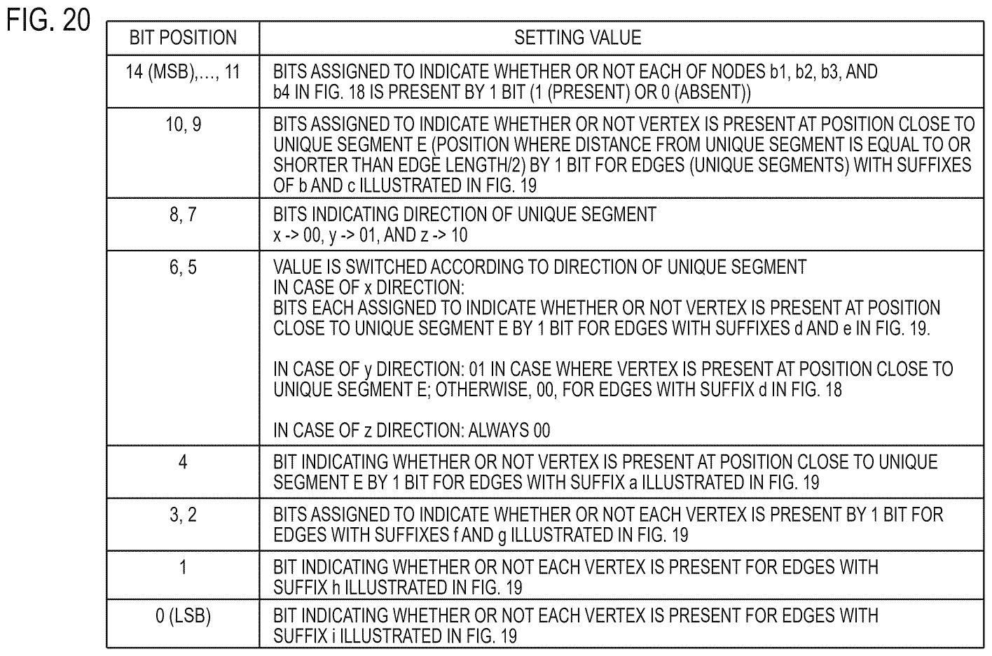

CtxMap2 may be configured as illustrated in FIG. 20, for example. As illustrated in FIG. 20, CtxMap2 has 15-bit information. In other words, CtxMap2 has 2¹⁵ values.

The approximate-surface synthesizing unit 2030 decodes the information indicating the presence or absence of the vertex, and then proceeds to step S1206.

In step S1206, the approximate-surface synthesizing unit 2030 determines whether or not the vertex is present in the unique segment.

Based on the information indicating the presence or absence of the vertex decoded in step S1205, in a case where the vertex is present, the approximate-surface synthesizing unit 2030 proceeds to step S1207. In a case where such a vertex is not present, the approximate-surface synthesizing unit 2030 proceeds to step S1202 and proceeds to the processing of the next unique segment.

In step S1207, the approximate-surface synthesizing unit 2030 decodes the “vertex position on the segment” in the unique segment for which the approximate-surface synthesizing unit 2030 has determined that the vertex is present. Here, the vertex position may be entropy-coded. At the time of entropy coding (encoding device)/decoding (decoding device), the approximate-surface synthesizing unit 2030 may prepare a plurality of probability models and select a probability model according to the context. The context may be set, for example, based on the information regarding the adjacent segment stored in step S906.

An example of the context setting method will be described below with reference to FIGS. 18, 19, 21, and 22.

The vertex position may be decoded bit by bit sequentially from the MSB as follows. Further, the context of the vertex position may include CtxMap1 (or primary Information) and CtxMap2 (secondary information), similarly to the context of the presence or absence of the vertex described above.

First, an example of generation of the context of the first bit (MSB) will be described.

CtxMap1 may be configured as follows, for example.

$$CtxMap 1 = ctxFullNbounds \times 2 + ( nclosestStart > 0 ? 1 : 0 )$$

Here, ctxFullNbounds may be defined as follows.

$$ctxFullNbounds = ( 4 \times ( ctx 0 <= 1 ? 0 : ( ctx 0 >= 3 ? 2 : 1 ) ) + max ( 1 , ctx 1 ) - 1 ) ) \times 2 + ( ctxE == 3 ? 0 : 1 )$$

Here, ctx0 represents the number of nodes that are present among the nodes b1 to b4 in FIG. 18B.

In addition, max(A,B) is a function that returns the larger value of two arguments A and B.

Further, ctxE represents a value obtained by subtracting 1 from the number of nodes that are present among the nodes e1 to e4 in FIG. 18A.

nclosestStart represents the number of edges whose vertices are present at positions closest to the unique segment E (positions where a distance from the unique segment is equal to or shorter than an edge length/4) among the edges with suffixes a to e illustrated in FIGS. 19A to 19C.

As described above, CtxMap1 has 3×4×2×2=48 (<2⁶) values. In other words, CtxMap1 can represent all values that can be taken as a 6-bit binary number.

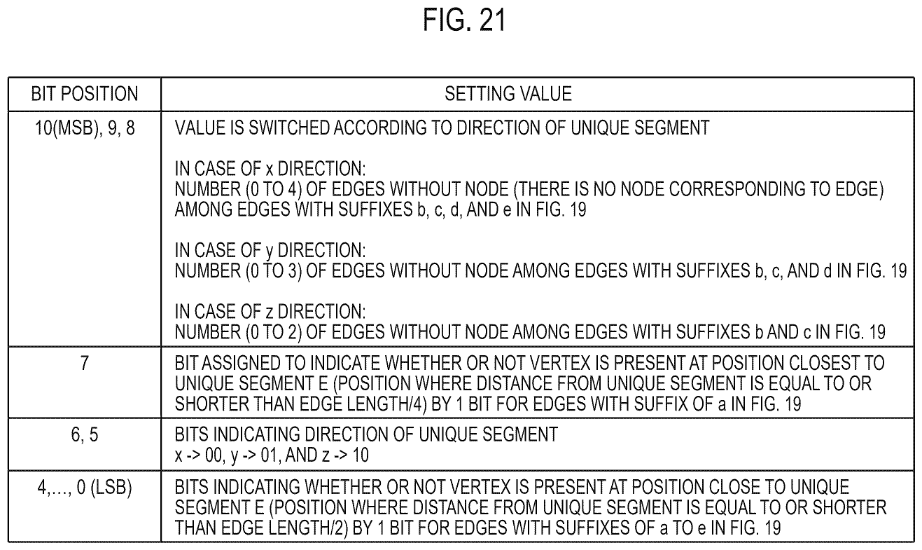

CtxMap2 may be configured as illustrated in FIG. 21, for example. As illustrated in FIG. 21, CtxMap2 has 11-bit information. In other words, CtxMap2 has 2¹¹ values.

Next, an example of generation of the context of the second bit will be described.

CtxMap1 may be configured as follows, for example.

$$CtxMap 1 = ( CtxMap 1 of first bit ) < < 1 + decoding result of first bit$$

Here, <<1 means shifting to the left by 1 bit. As described above, CtxMap1 has 48×2=96 (<27) values. In other words, CtxMap1 can represent all values that can be taken as a 7-bit binary number.

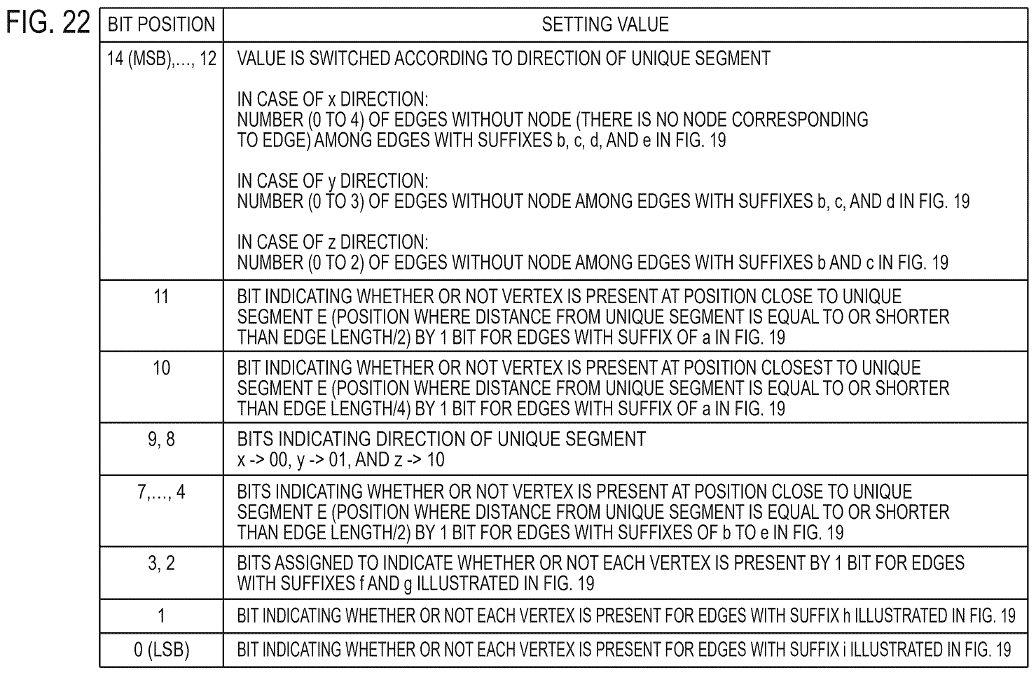

CtxMap2 may be configured as illustrated in FIG. 22, for example. As illustrated in FIG. 22, CtxMap2 has 15-bit information. In other words, CtxMap2 has 2¹⁵ values.

Here, the vertex position may be decoded with bit precision specified by the syntax (trisoup_vertex_number_bits) that specifies the precision (bit number) of the vertex position of Trisoup described above.

For example, in a case where trisoup_vertex_number_bits is 2, decoding may be performed so as to have four types of values of 0, 1, 2, and 3. Furthermore, in a case where trisoup_vertex_number_bits is decoded for each depth, decoding may be performed with bit precision corresponding to the depth.

In addition, the bit precision specified by trisoup_vertex_number_bits may be used only at a depth (the largest depth) corresponding to the minimum Trisoup node size, and thereafter, as the node size increases by 1 (the depth decreases by 1), the bit precision may be increased by 1.

For example, in a case where there are two types of node sizes (two stages of minimum and maximum), the vertex position may be decoded using, as the bit precision for the depth, a value of trisoup_vertex_number_bits at a depth corresponding to the minimum Trisoup node size, and using, as the bit precision for the depth, a value obtained by adding 1 to trisoup_vertex_number_bits at a depth corresponding to the maximum Trisoup node size.

As described above, the approximate-surface synthesizing unit 2030 is configured to decode the presence or absence of the vertex and the position of the vertex by using a plurality of contexts, and prepare and initialize the contexts as many as the minimum necessary number based on a value that can be taken by the context prior to such decoding processing.

After decoding the vertex position, the approximate-surface synthesizing unit 2030 proceeds to step S1202 and proceeds to the processing of the next unique segment.

Although an example in which the approximate-surface synthesizing unit 2030 uses the “interpolated vertex” as it is as the vertex position in step S1204 has been described above, the approximate-surface synthesizing unit 2030 may decode the presence or absence of the vertex and the vertex position based on the information regarding the “interpolated vertex”.

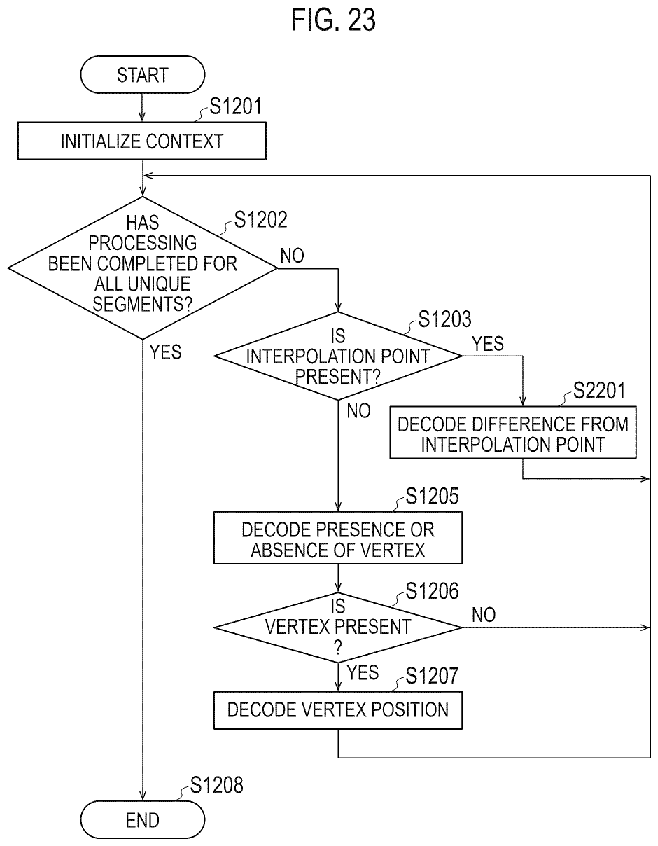

For example, as illustrated in FIG. 23, for the unique segment in which the “interpolated vertex” is present, the approximate-surface synthesizing unit 2030 may decode a difference value from the position of the “interpolated vertex” in step S2201, and add the decoded difference value to the position of the “interpolated vertex” to obtain the decoded value of the vertex position in the unique segment.

At this time, the approximate-surface synthesizing unit 2030 may limit the difference value to a range of −d to +d. For example, the approximate-surface synthesizing unit 2030 may set d to 1. In such a case, the difference value is limited to three values of −1, 0, and +1.

At this time, the approximate-surface synthesizing unit 2030 may perform binarization such that the first bit indicates whether or not the absolute value is 0, and the second bit indicates a code in a case where the absolute value is 1, such as 0=>0, +1=>10, and −1=>11, and then perform entropy decoding on the assumption that entropy coding is performed for each bit.

In such a case, the approximate-surface synthesizing unit 2030 may prepare different contexts for the first bit and the second bit and update the probability distribution used for entropy decoding.

Furthermore, in a case where such difference encoding is performed hierarchically between a plurality of node sizes, the approximate-surface synthesizing unit 2030 may be configured to obtain a final difference value by applying inverse transformation (inverse Wavelet transform or the like) to a transformation coefficient of the decoded difference value on the assumption that transformation processing such as Wavelet transform is applied to the difference value.

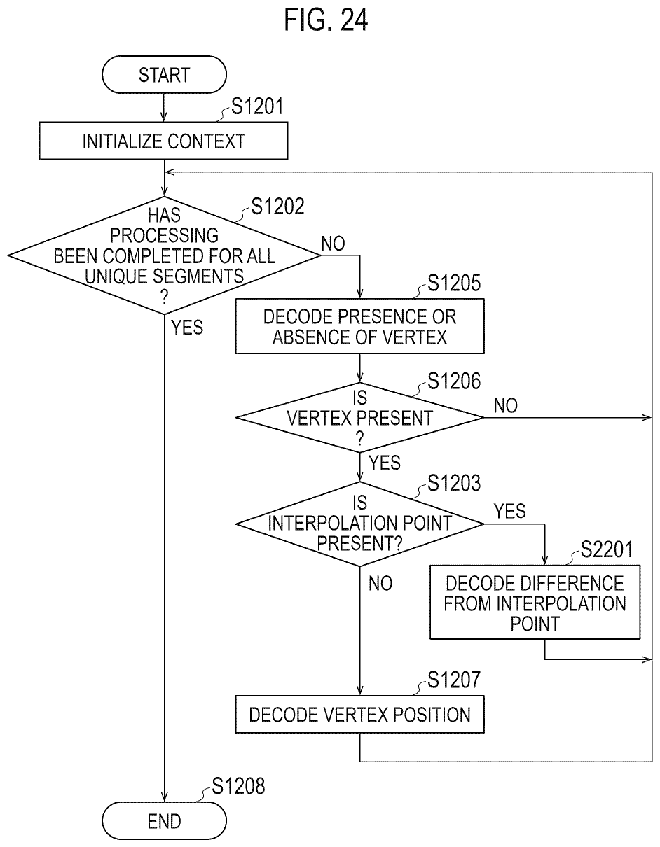

Furthermore, for example, as illustrated in FIG. 24, the approximate-surface synthesizing unit 2030 may change the order of processing, and determine whether or not the “interpolated vertex” is present for the unique segment decoded to be “with vertex”.

Further, in a case where the “interpolated vertex” is present in the unique segment, the approximate-surface synthesizing unit 2030 may decode the difference value from the position of the “interpolated vertex”, and add the decoded difference value to the position of the “interpolated vertex” to obtain the decoded value of the vertex position in the unique segment, similarly to the example of FIG. 24.

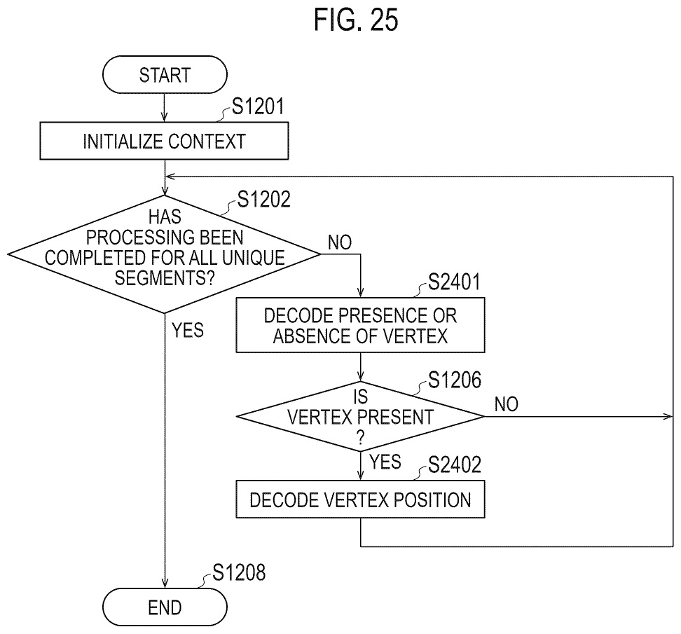

Furthermore, for example, as illustrated in FIG. 25, the approximate-surface synthesizing unit 2030 may decode each of the presence or absence of the vertex and decode the vertex position by using the information regarding the “interpolated vertex”.

Hereinafter, a specific example of the processing of step S2401 and step S2402, which corresponds to a difference from FIG. 12, will be described.

As illustrated in FIG. 25, in step S2401, when decoding the presence or absence of the vertex of the unique segment, the approximate-surface synthesizing unit 2030 switches the context according to whether or not the “interpolated vertex” is present in the unique segment, and performs entropy decoding based on the context.

Here, the approximate-surface synthesizing unit 2030 may use the context in combination with the context described in step S1205.

As described above, after the presence/absence of the vertex is decoded, the present operation proceeds to step S1206.

In step S2402, when decoding the vertex position of the unique segment, the approximate-surface synthesizing unit 2030 performs entropy decoding based on whether or not the “interpolated vertex” is present in the unique segment, and performs entropy decoding based on the vertex position in a case where the “interpolated vertex” is present in the unique segment.

For example, in a case where the approximate-surface synthesizing unit 2030 quantizes the position of the “interpolated vertex” by 2 bits (limited to 4), four positions+a case where the interpolated vertex is not present=a total of five contexts.

Furthermore, the approximate-surface synthesizing unit 2030 may use the contexts in combination with the context described in step S1207.

As described above, the approximate-surface synthesizing unit 2030 is configured to decode vertex information of Trisoup at each node size in order from the larger node size.

Here, such vertex information includes at least one of the presence or absence of the vertex for each unique segment and the vertex position for each unique segment.

Then, in a case where there is a decoded node size larger than the node size (target node size), the approximate-surface synthesizing unit 2030 may be configured to generate a predicted value of the vertex information at the node size based on Trisoup vertex information at the decoded node size, and to decode the vertex information of the node size by using the predicted value.

Furthermore, as described with reference to FIGS. 23 and 24, the approximate-surface synthesizing unit 2030 may be configured to generate a predicted value based on the vertex position for each unique segment at the decoded node size in a case where there is a decoded node size larger than the node size (target node size), to decode a difference value between the predicted value and the vertex position of the unique segment at the node size in a case where there is a predicted value of the vertex information in the unique segment (target unique segment) at the node size, and to decode the vertex position of the unique segment at the node size by adding the difference value and the predicted value.

With such a configuration, encoding efficiency can be improved as compared with a case where the vertex position of Trisoup is directly decoded.

Furthermore, as described with reference to FIG. 25, the approximate-surface synthesizing unit 2030 may be configured to generate a predicted value based on the vertex position for each unique segment at the decoded node size in a case where there is a decoded node size larger than the node size (target node size), to switch the context based on whether or not there is a predicted value of the vertex information in the unique segment (target unique segment) at the node size, and to decode the presence or absence of the vertex of the unique segment by using the context.

With such a configuration, entropy decoding can be performed using different contexts (probability distributions) depending on the presence or absence of the predicted value, and thus, encoding efficiency can be improved.

Furthermore, as described with reference to FIG. 25, the approximate-surface synthesizing unit 2030 may be configured to generate a predicted value based on the vertex position for each unique segment at the decoded node size in a case where there is a decoded node size larger than the node size (target node size), to switch the context based on the predicted value in a case where there is a predicted value of the vertex information in the unique segment (target unique segment) at the node size, and to decode the vertex position of the unique segment by using the context.

With such a configuration, entropy decoding can be performed using different contexts (probability distributions) based on the predicted value, and thus, encoding efficiency can be improved.

Furthermore, the approximate-surface synthesizing unit 2030 may apply the difference encoding described with reference to FIGS. 23 and 24 and the context switching based on the predicted value, which is described with reference to FIG. 25, only to the unique segment positioned at a boundary (a CTU boundary in the case of selecting the node size in units of CTUs) between different node sizes.

As described above, the approximate-surface synthesizing unit 2030 decodes the vertex in step S705, and then proceeds to step S706.

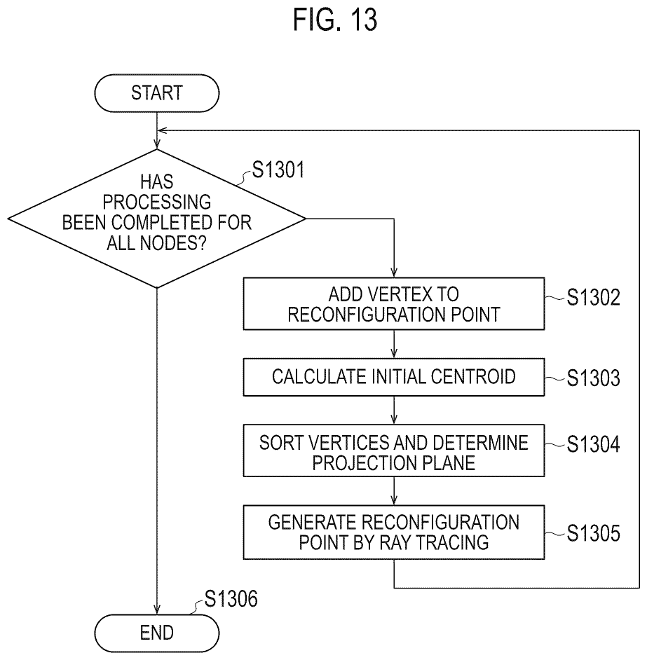

In step S706, the approximate-surface synthesizing unit 2030 generates a reconfiguration point cloud based on the vertex decoded in step S705. FIG. 13 is a flowchart illustrating an example of a method of generating the reconfiguration point cloud. Hereinafter, an example of the processing of step S706 will be described with reference to FIG. 13.

As illustrated in FIG. 13, in step S1301, the approximate-surface synthesizing unit 2030 determines whether or not the processing has been completed for all the Trisoup nodes at the value of trisoup_depth.

In a case where the processing has been completed for all the Trisoup nodes, the present operation proceeds to step S1306, and the processing is terminated. In a case where the processing has not been completed for all the Trisoup nodes, the present operation proceeds to step S1302.

In step S1302, first, the approximate-surface synthesizing unit 2030 specifies the unique segment corresponding to each side (segment) of the Trisoup node. For example, the approximate-surface synthesizing unit 2030 can specify the unique segment by searching for a unique segment whose start point coordinates and end point coordinates of each side (segment) of the Trisoup node are the same from among the unique segments processed in step S705.

Second, in a case where the vertex is present in the specified unique segment, the approximate-surface synthesizing unit 2030 adds the vertex to the reconfiguration point cloud by the following procedure.

(1) The approximate-surface synthesizing unit 2030 shifts the position of the segment by −0.5. Specifically, the approximate-surface synthesizing unit 2030 subtracts 0.5 from the coordinate values on the axes other than the axis along the direction of the segment for each of the start point coordinates and the end point coordinates of the segment.

For example, when the start point coordinates of the segment are (x,y,z)=(12,100,32), the node size is 4, and the direction of the segment is the x axis, the end point coordinates are (16,100,32) obtained by adding the node size to the x coordinate of the start point.

On the other hand, the axes other than the x axis, that is, the y coordinate and the z coordinate in such an example, are each decreased by 0.5. Therefore, the start point coordinates and the end point coordinates are (12,99.5,31.5) and (16,99.5,31.5), respectively.

(2) The approximate-surface synthesizing unit 2030 adds the “vertex position on the segment” of the segment to the start point coordinates. For example, in the above example, in a case where the “vertex position on the segment” is 2, (14,99.5,31.5) is obtained.

(3) The approximate-surface synthesizing unit 2030 adds 0.5 to the coordinate values on the axes other than the axis along the direction of the segment for the coordinates obtained in (2) described above. For example, in the above example, (14,100,32) is obtained. Since the same result can be obtained by adding the vertex position of 2 on the unique segment to the start point coordinates (12,100,32) of the unique segment before the procedure of (1) described above is performed, the approximate-surface synthesizing unit 2030 may perform the calculation as described above.

(4) In a case where the coordinates calculated in (3) described above are present inside the Trisoup node, the approximate-surface synthesizing unit 2030 generates a point at the coordinates calculated in (3) described above and adds the point to the reconfiguration point cloud.

Here, the inside of the Trisoup node corresponds to a point whose values of x, y, and z coordinates are each present in a range of the start point (a point having the smallest x coordinate, y coordinate, and z coordinate) of the Trisoup node+the Trisoup node size−1.

For example, in a case where the start point coordinates of the Trisoup node are (x,y,z)=(12,100,32) and the Trisoup node size is 4, a point present in a range of (12 to 15,100 to 103,32 to 35) is regarded as the inside of the Trisoup node.

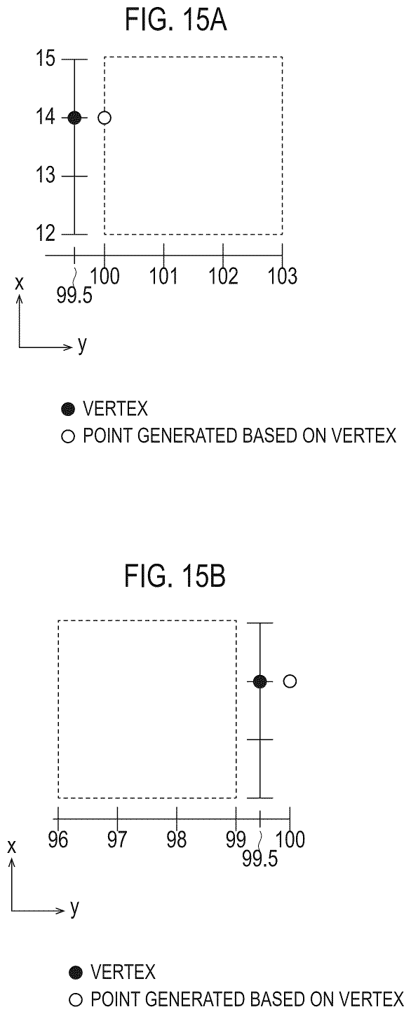

In this case, when the coordinates calculated in (3) described above are (14,100,32), it is determined that the coordinates are inside the Trisoup node, and the approximate-surface synthesizing unit 2030 adds the point at the coordinates to the reconfiguration point cloud. FIG. 15A illustrates a case where such a result is projected on an x-y plane.

On the other hand, for example, in a case where the start point coordinates of the Trisoup node are (x,y,z)=(12,96,32), a point in a range of (12 to 15,96 to 99,32 to 35) is inside the Trisoup node. Therefore, in this case, it is determined that a point whose coordinate values are (14,100,32) is not present inside the Trisoup node, and the present operation terminates the processing without adding the point corresponding to the coordinates calculated in (3) to the reconfiguration point cloud. FIG. 15B illustrates an example of such a case.

After terminating the above processing, the present operation proceeds to step S1303.

In step S1303, the approximate-surface synthesizing unit 2030 calculates initial coordinates of the centroid from the vertex corresponding to the Trisoup node.

For example, the initial coordinates of the centroid can be calculated by averaging x, y, and z components of all the vertex positions of the Trisoup node. In a case where the number of vertices of the Trisoup node is three or less, calculation of centroid processing may be omitted.

After such processing is completed, the present operation proceeds to step S1304.

In step S1304, the approximate-surface synthesizing unit 2030 performs vertex sorting and projection plane determination processing. Specifically, for example, the approximate-surface synthesizing unit 2030 can sort vertices and determine a projection plane by the following procedure.

(1) The approximate-surface synthesizing unit 2030 projects the vertex onto the x-y plane. Such processing is equivalent to extracting the values of the x coordinate and the y coordinate from the respective vertex coordinates.

Since the vertex is originally present on a side of the node, in a projected planar shape, each vertex is present on a side of a square or rectangle obtained by projecting the node on the plane. Since the square is also a type of rectangle, the shape of the projected node will be described as a rectangle in the following description.

(2) The approximate-surface synthesizing unit 2030 sorts points on the sides of the rectangle obtained by projecting the node in a clockwise or counterclockwise order.

In addition, the approximate-surface synthesizing unit 2030 assigns a provisional index value (0, 1, 2, or the like) to each vertex in the order of sorting.

(3) The approximate-surface synthesizing unit 2030 defines a triangle defined by three points of two adjacent vertices and the centroid in the order of sorting, and calculates an area of the triangle. The area of the triangle can be calculated, for example, by generating vectors respectively directed to two vertex coordinates with the centroid as a start point and using an outer product thereof.

As described above, the approximate-surface synthesizing unit 2030 calculates and adds the area of the triangle for all combinations (0,1), (1,2), . . . , and (N,0) of two vertices adjacent in the order of sorting.

Note that, in a case where there are only three vertices, the approximate-surface synthesizing unit 2030 calculates the area of the triangle defined by the three vertices without using the centroid. In addition, the area is an area on the projected planar shape.

(4) The approximate-surface synthesizing unit 2030 similarly performs the above-described procedures (1) to (3) also for an x-z plane and a y-z plane, sets a plane having the largest area calculated in (3) described above as the projection plane, and at this time, adopts the order of sorting in (2) described above and the assigned provisional index as the final order of sorting and the index.

As described above, after sorting the vertices and determining the projection plane, the approximate-surface synthesizing unit 2030 proceeds to step S1305.

In step S1305, the approximate-surface synthesizing unit 2030 generates the reconfiguration point cloud with the triangle generated in step S1304 and ray tracing.

Specifically, the approximate-surface synthesizing unit 2030 generates the reconfiguration point cloud by the following procedure.

(1) First, the approximate-surface synthesizing unit 2030 generates a triangle based on the index and the centroid determined in step S1304, similarly to step S1304. However, the approximate-surface synthesizing unit 2030 generates the triangle on a two-dimensional plane in step S1304, and generates the triangle on a three-dimensional space by using all the x, y, and z coordinates of each vertex in step S1305.

(2) Second, the approximate-surface synthesizing unit 2030 defines a normal vector (a vector in the z direction if the projection plane is the x-y plane) of the projection plane and arranges the normal vector on the projection plane.

For example, the approximate-surface synthesizing unit 2030 sets, as an initial position, a point closest to the origin of the node shape (that is, the rectangle) on the projection plane.

(3) Third, when increasing the norm of the normal vector, the approximate-surface synthesizing unit 2030 determines whether or not the normal vector intersects the triangle generated in (1) described above, and calculates coordinates of an intersection in a case where the normal vector intersects the triangle.

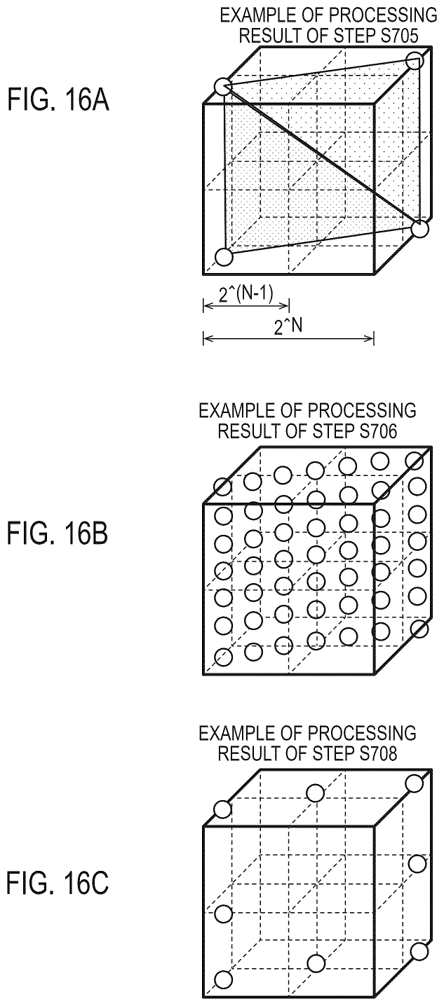

For example, the approximate-surface synthesizing unit 2030 can implement such processing by using a general ray tracing method or the like. FIG. 16A illustrates an example of a configuration of the triangle.

(4) Fourth, in a case where the coordinates at which the normal vector calculated in (3) described above and the triangle intersect each other is present inside the Trisoup node, the approximate-surface synthesizing unit 2030 generates a point at the coordinate position and adds the point to the reconfiguration point cloud.

(5) Fifth, the approximate-surface synthesizing unit 2030 repeats the above-described procedures (3) and (4) for a case of arrangement at each integer coordinate position in the node (rectangle) on the projection plane.

At this time, an interval at which the normal vectors are arranged may be 1 (that is, all integer coordinate positions). Here, the interval of 1 is the smallest possible interval. An example of the reconfiguration point cloud generated from the triangle of FIG. 16A is illustrated in FIG. 16B.

After generating the reconfiguration point for the Trisoup node as described above, the approximate-surface synthesizing unit 2030 proceeds to step S1301 and proceeds to the processing of the next Trisoup node.

As described above, in step S706, the approximate-surface synthesizing unit 2030 generates the reconfiguration point cloud, and then proceeds to step S707.

In step S707, the approximate-surface synthesizing unit 2030 determines whether or not the Trisoup node size at the value of trisoup_depth is the minimum Trisoup node size.

In a case where the Trisoup node size is the minimum Trisoup node size, the present operation proceeds to step S701. Otherwise, that is, in a case where the Trisoup node size at the value of trisoup_depth is larger than the minimum Trisoup node size, the present operation proceeds to step S708.

In step S708, the approximate-surface synthesizing unit 2030 interpolates the vertex on the segment of the node at the minimum Trisoup node size based on the vertex corresponding to the Trisoup node size at trisoup_depth decoded in step S705.

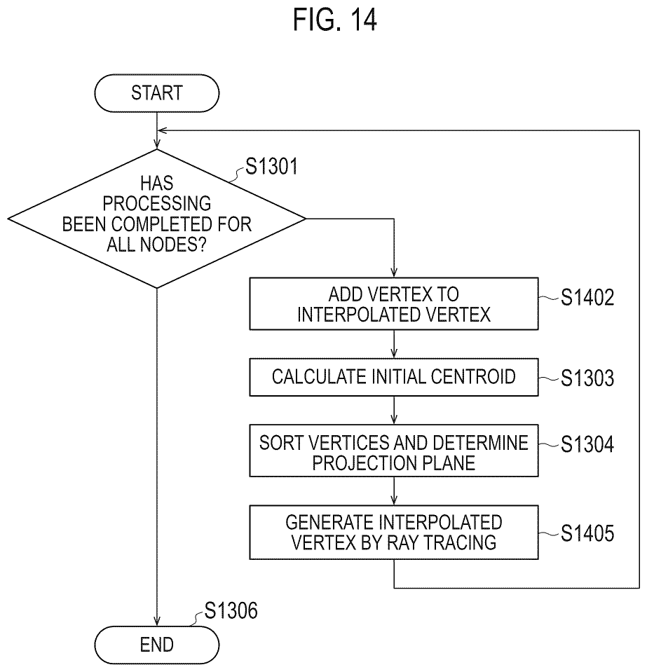

FIG. 14 is a flowchart illustrating an example of the processing of step S708. Hereinafter, a processing example of step S708 will be described with reference to FIG. 14. Note that the processing of FIG. 14 is almost the same as the processing of FIG. 13, and the same processing is denoted by the same reference numeral. Hereinafter, only differences from FIG. 13 will be described.

As illustrated in FIG. 14, in step S1402, the approximate-surface synthesizing unit 2030 stores the vertex of the Trisoup node as the “interpolated vertex”.

Specifically, the approximate-surface synthesizing unit 2030 stores the coordinate values after performing the procedures (1) and (2) described in step S1302 as they are as the “interpolated vertex”.

For example, in the example of step S1302, the approximate-surface synthesizing unit 2030 stores coordinate values of (14,99.5,31.5) as the “interpolated vertex”. This is because the position of the segment is defined to be shifted by 0.5 from the integer coordinate position.

Furthermore, in order to hold the value as an integer, the approximate-surface synthesizing unit 2030 may hold the value as a value obtained by doubling the true coordinate value. In the above example, the approximate-surface synthesizing unit 2030 may store values of (28,199,63) as the “interpolated vertex”.

In step S1405, the approximate-surface synthesizing unit 2030 changes a position where the normal vector is arranged in the procedure (2) of step S1305 to a position where the segment when the Trisoup node is divided by the minimum Trisoup node size is present.

In a case where the intersecting coordinates calculated in the same manner as in the procedure (3) of step S1305 are on the segment when the Trisoup node is divided by the minimum Trisoup node size, the approximate-surface synthesizing unit 2030 stores such coordinate values as the “interpolated vertex”.

In a case where a value converted into an integer by doubling the coordinate value is stored in step S1402, the approximate-surface synthesizing unit 2030 also stores a value obtained by doubling the coordinate value in step S1405.

The approximate-surface synthesizing unit 2030 stores the “interpolated vertex” generated by the above processing, and uses the “interpolated vertex” in step S703 at the next value of trisoup_depth.

Furthermore, in a case where the value of trisoup_depth is larger than 0, that is, in a case where the Trisoup node size at the value of trisoup_depth is not the maximum Trisoup node size, the “interpolated vertex” generated with a larger node size is present, but the approximate-surface synthesizing unit 2030 does not delete a set of the “interpolated vertices”, and stores the “interpolated vertex” newly generated in step S1402 in the form of being added to the above-described set.

Note that, in a case where the interpolated vertex is used only between the nodes or between CTU nodes (a case where the difference coding described in FIGS. 23 and 24 or the context construction described in FIG. 25 is performed only between the nodes or between the CTU nodes), the approximate-surface synthesizing unit 2030 may store only “interpolated vertices” present on the surface of the Trisoup node among the “interpolated vertices” as illustrated in FIG. 16C.

Alternatively, the approximate-surface synthesizing unit 2030 may store only “interpolated vertices” present on the surface of the CTU node (a node that decodes the Trisoup node size) among the “interpolated vertices”.

That is, the approximate-surface synthesizing unit 2030 may be configured to generate the predicted value of vertex information at a small node size from the vertex information at a large node size in the unique segment positioned at the boundary between different node sizes.

The memory amount can be reduced by storing only the vertices necessary for the processing as described above.

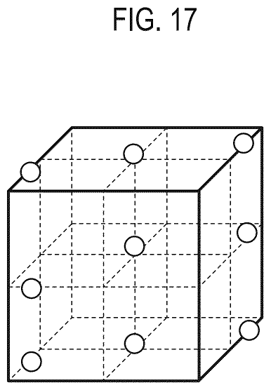

Furthermore, in a case where the interpolated vertex is used in all the unique segments, that is, in a case where the pieces of vertex information of all the nodes are hierarchically encoded in descending order of the node size, the approximate-surface synthesizing unit 2030 may store all the “interpolated vertices” as illustrated in FIG. 17.

Note that, here, for the sake of convenience, step S706 and step S708 have been described as separate steps of processing, but steps S706 and S708 may be performed at the same time since steps S706 and S708 have many common parts.

For example, the approximate-surface synthesizing unit 2030 may also perform step S1402 in a case where the condition of step S707 is satisfied in step S1302, and may also perform step S1405 in a case where the condition of step S707 is satisfied in step S1305.

As described above, the approximate-surface synthesizing unit 2030 in the present embodiment may be configured to decode, for each node having the predetermined size, the node size at which Trisoup is to be applied to the descendant nodes obtained by recursively dividing the node by octree.

Furthermore, as described above, the approximate-surface synthesizing unit 2030 in the present embodiment may be configured to perform context-adaptive decoding by using the information regarding the presence or absence of the vertex and the vertex position of spatially adjacent decoded segments when decoding the presence or absence of the vertex and the vertex position of each segment included in the Trisoup node.

Furthermore, as described above, the approximate-surface synthesizing unit 2030 in the present embodiment may be configured to perform context-adaptive decoding by using information regarding the presence or absence of the vertex and the vertex position of a segment included in a node having the same size as the Trisoup node among spatially adjacent decoded segments when decoding the presence or absence of the vertex and the vertex position of each segment included in the Trisoup node.

With such a configuration, the Trisoup nodes of the same size become adjacent to each other in a local region while an appropriate Trisoup node size is selected according to characteristics of a point cloud for each local region, and thus, encoding efficiency is improved by utilizing a correlation in a spatial direction.

### (Point Cloud Encoding Device 100)

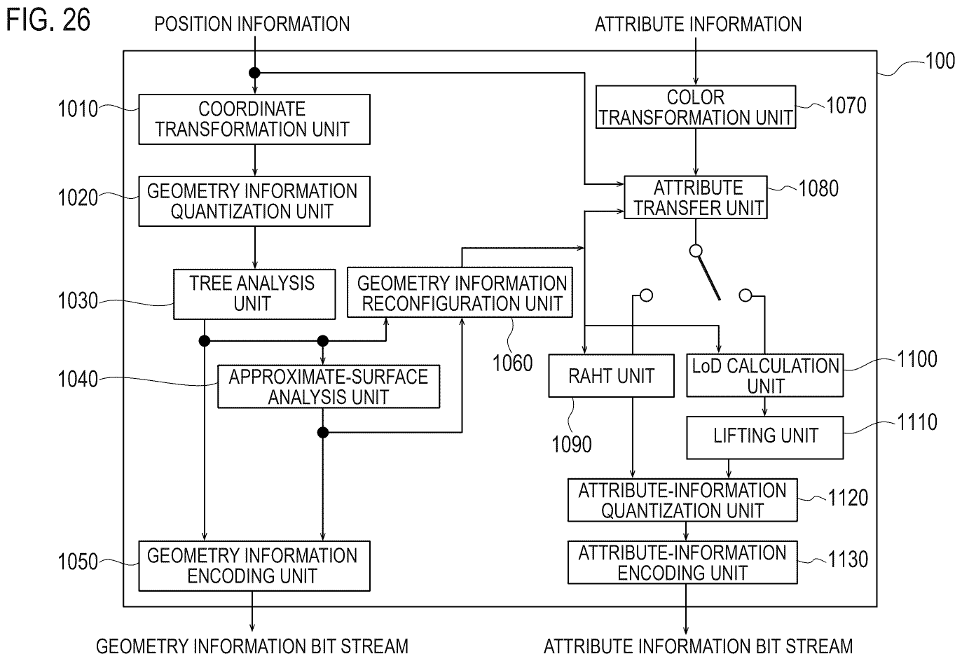

Hereinafter, the point cloud encoding device 100 according to the present embodiment will be described with reference to FIG. 26. FIG. 26 is a diagram illustrating an example of functional blocks of the point cloud encoding device 100 according to the present embodiment.

As illustrated in FIG. 26, the point cloud encoding device 100 includes a coordinate transformation unit 1010, a geometry information quantization unit 1020, a tree analysis unit 1030, an approximate-surface analysis unit 1040, a geometry information encoding unit 1050, a geometry information reconfiguration unit 1060, a color transformation unit 1070, an attribute transfer unit 1080, an RAHT unit 1090, an LoD calculation unit 1100, a lifting unit 1110, an attribute-information quantization unit 1120, and an attribute-information encoding unit 1130.

The coordinate transformation unit 1010 is configured to perform transformation processing from a three-dimensional coordinate system of an input point cloud to an arbitrary different coordinate system. In the coordinate transformation, for example, x, y, and z coordinates of the input point cloud may be transformed into arbitrary s, t, and u coordinates by rotating the input point cloud. Furthermore, as one of variations of the transformation, the coordinate system of the input point cloud may be used as it is.

The geometry information quantization unit 1020 is configured to perform quantization of position information of the input point cloud after the coordinate transformation and removal of points having overlapping coordinates. Note that, in a case where a quantization step size is 1, the position information of the input point cloud matches position information after quantization. That is, a case where the quantization step size is 1 is equivalent to a case where quantization is not performed.

The tree analysis unit 1030 is configured to generate an occupancy code indicating which node in an encoding target space a point is present, based on a tree structure to be described later, by using the position information of the point cloud after quantization as an input.

In the present processing, the tree analysis unit 1030 is configured to recursively partition the encoding target space into cuboids to generate the tree structure.

Here, in a case where a point is present in a certain cuboid, the tree structure can be generated by recursively performing processing of dividing the cuboid into a plurality of cuboids until the cuboid has a predetermined size. Each of such cuboids is referred to as a node. In addition, each cuboid generated by dividing the node is referred to as a child node, and the occupancy code is a code expressed by 0 or 1 as to whether or not a point is included in the child node.

As described above, the tree analysis unit 1030 is configured to generate the occupancy code while recursively dividing the node to a predetermined size.

In the present embodiment, it is possible to use a method called “octree” in which octree division is recursively carried out with the above-described cuboids always as cubes, and a method called “QtBt” in which quadtree division and binary tree division are carried out in addition to octree division.

Here, whether or not to use “QtBt” is transmitted to the point cloud decoding device 200 as control data.

Alternatively, it may be specified that Predictive coding using any tree configuration is to be used. In such a case, the tree analysis unit 1030 determines the tree structure, and the determined tree structure is transmitted to the point cloud decoding device 200 as control data.

For example, the control data of the tree structure may be configured to be decoded by the procedure described in FIG. 6.

The approximate-surface analysis unit 1040 is configured to generate approximate-surface information by using the tree information generated by the tree analysis unit 1030.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

Specifically, the approximate-surface analysis unit 1040 may be configured to generate the approximate-surface information by, for example, a method called “Trisoup”. In addition, when decoding a sparse point cloud acquired by Lidar or the like, the present processing can be omitted.

The geometry information encoding unit 1050 is configured to encode syntax such as the occupancy code generated by the tree analysis unit 1030 and the approximate-surface information generated by the approximate-surface analysis unit 1040 to generate a bit stream (geometry information bit stream). Here, the bit stream may include, for example, the syntax described in FIGS. 4 and 5.

The encoding processing is, for example, context-adaptive binary arithmetic encoding processing. Here, for example, the syntax includes control data (flags and parameters) for controlling the decoding processing of the position information.

The geometry information reconfiguration unit 1060 is configured to reconfigure geometry information (a coordinate system assumed by the encoding processing, that is, the position information after the coordinate transformation in the coordinate transformation unit 1010) of each point of the point cloud data to be encoded based on the tree information generated by the tree analysis unit 1030 and the approximate-surface information generated by the approximate-surface analysis unit 1040.

The color transformation unit 1070 is configured to perform color transformation when attribute information of the input is color information. The color transformation is not necessarily performed, and whether or not to perform the color transformation processing is encoded as a part of the control data and transmitted to the point cloud decoding device 200.

The attribute transfer unit 1080 is configured to correct an attribute value so as to minimize distortion of the attribute information based on the position information of the input point cloud, the position information of the point cloud after the reconfiguration in the geometry information reconfiguration unit 1060, and the attribute information after the color change in the color transformation unit 1070.

The RAHT unit 1090 is configured to use, as input, the attribute information after the transfer by the attribute transfer unit 1080 and the geometry information generated by the geometry information reconfiguration unit 1060, and to generate residual information of each point by using a type of Haar transform called region adaptive hierarchical transform (RAHT). As specific processing of the RAHT, for example, the method described in Literature 2 described above can be used.

The LoD calculation unit 1100 is configured to generate a level of detail (LoD) using the geometry information generated by the geometry information reconfiguration unit 1060 as an input.

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Literature 2 described above may be used.

The lifting unit 1110 is configured to generate the residual information by lifting processing using the LoD generated by the LoD calculation unit 1100 and the attribute information after the attribute transfer in the attribute transfer unit 1080.

As specific processing of lifting, for example, the method described in Literature (Text of ISO/IEC 23090-9 DIS Geometry-based PCC, ISO/IEC JTC1/SC29/WG11 N19088) may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using the quantized residual information or the like output from the attribute-information quantization unit 1120 as syntax to generate a bit stream (attribute information bit stream) regarding the attribute information.

The encoding processing is, for example, context-adaptive binary arithmetic encoding processing. Here, for example, the syntax includes control data (flags and parameters) for controlling the decoding processing of the attribute information.

The point cloud encoding device 100 is configured to perform the encoding processing using the position information and the attribute information of each point in a point cloud as inputs and output the geometry information bit stream and the attribute information bit stream by the above processing.

The point cloud encoding device 100 and the point cloud decoding device 200 described above may be implemented as programs that cause a computer to execute each function (each step).

In the above embodiments, the present invention has been described using the application to the point cloud encoding device 100 and the point cloud decoding device 200 as an example. However, the present invention is not limited to such examples and can similarly be applied to a point cloud encoding/decoding system that incorporates the respective functions of the point cloud encoding device 100 and the point cloud decoding device 200.

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A point cloud decoding device comprising a circuit, wherein
the circuit decodes vertex information of Trisoup,
the vertex information includes at least one of a presence or absence of a vertex for each unique segment or a vertex position for each unique segment,
the presence or absence of the vertex and the position of the vertex are each decoded using a plurality of contexts, and
the contexts are prepared in a minimum necessary number based on values takeable by the context, and initialized before the decoding processing.

2. A point cloud decoding method comprising:
decoding vertex information of Trisoup, wherein
the vertex information includes at least one of a presence or absence of a vertex for each unique segment or a vertex position for each unique segment,
the presence or absence of the vertex and the position of the vertex are each decoded using a plurality of contexts, and
the contexts are prepared in a minimum necessary number based on values takeable by the context, and initialized before the decoding processing.

3. A program for causing a computer to function as a point cloud decoding device, wherein
the point cloud decoding device includes a circuit that decodes vertex information of Trisoup,
the vertex information includes at least one of a presence or absence of a vertex for each unique segment or a vertex position for each unique segment,
the presence or absence of the vertex and the position of the vertex are each decoded using a plurality of contexts, and
the contexts are prepared in a minimum necessary number based on values takeable by the context, and initialized before the decoding processing.
